(19) United States
(12) Patent Application Publication
(10) Pub. No.: US 2026/0249192 A1
(43) Pub. Date: Aug. 27, 2026

(54) SYSTEM AND METHOD FOR MANAGING AVATARS FOR USE IN MULTIPLE 3D RENDERING PLATFORMS

(71) Applicant: Cross Game Play LLC, Dacula, GA (US)

(72) Inventors: Kelvin John Troy, Dublin (IE); John Michael O'Connor, Down (IE)

(21) Appl. No.: 19/652,045

(22) Filed: Apr. 20, 2026

Related U.S. Application Data
(63) Continuation-in-part of application No. 19/306,300, filed on Aug. 21, 2025.
Application No. 19/306,300 is a continuation of application No. 18/323,529, filed on May 25, 2023, now Pat. No. 12,420,199.

(51) Int. Cl. A63F 13/63; A63F 13/52; A63F 13/60; A63F 13/79; G06F 8/20; G06F 9/54; G06T 15/00

(52) U.S. Cl. CPC A63F 13/63; A63F 13/52; A63F 13/60; A63F 13/79; G06F 8/20; G06F 9/547; G06T 15/005; A63F 2300/538; A63F 2300/5553; A63F 2300/66

(57) ABSTRACT

A system and method for managing a persistent digital avatar and its associated assets across multiple 3D rendering platforms is disclosed. In a further aspect, a governance framework maintains identity persistence and policy inheritance for such assets, particularly when they are recreated from indirect evidence. The framework uses a verifiable Derived-Asset Receipt to cryptographically bind an output asset to its evidence, reconstruction pipeline, and a governing policy anchor. Enforcement points within a destination pipeline, such as a game engine or marketplace, gate acceptance of the asset based on verification of the receipt, thereby preventing the use of non-compliant or unauthorized assets.

### CROSS REFERENCE TO RELATED APPLICATIONS

This application is a continuation-in-part of U.S. Patent Application No. 19/306,300 filed August 21, 2025, entitled “SYSTEM AND METHOD FOR MANAGING AVATARS FOR USE IN MULTIPLE 3D RENDERING PLATFORMS”, which is a continuation of U.S. patent application Ser. No. 18/323,529, filed on May 25, 2023, titled “SYSTEM AND METHOD FOR MANAGING AVATARS FOR USE IN MULTIPLE 3D RENDERING PLATFORMS”, issued as U.S. Patent No. 12,420,199 on September 23, 2025. The previous applications are incorporated herein by reference in their entirety.

### FIELD OF THE PRESENT DISCLOSURE

The present disclosure relates to a system and method for managing avatars and their associated assets across multiple 3D rendering platforms, such as video games, metaverses, and other 3D applications. More specifically, the present disclosure relates to a system that enables users to create, customize, and maintain a persistent digital avatar or identity with granular customization options that can be used across various platforms. Even more particularly, the present disclosure relates to computer-implemented digital asset pipeline governance, including systems that maintain identity persistence and policy inheritance when such avatars or assets are created via reconstruction, and that gate their acceptance and deployment at enterprise enforcement points.

### BACKGROUND

With the increasing popularity of virtual worlds, games, and metaverses, users often create and customize avatars to represent themselves in these environments. Many video games and other 3D applications exist that allow users to customize their avatars. These avatars are, in a way, a user's identity in the digital world.

However, current avatar customization solutions are typically limited to a single game or platform, resulting in users having to create and manage multiple avatars across different environments. When a user leaves one application and goes to another, the avatar designed in the previous application is confined to the application in which it was created. Additionally, any purchased cosmetics are not usable between applications, making them a poor investment. Such limitations can be frustrating for users, as they may invest time and resources into customizing their avatars in one environment, only to be unable to use them in another.

While some solutions allow users to create custom avatars for use in various virtual environments, they often require users to manually export and import their avatars and associated assets, which can be cumbersome and time-consuming. There is a need for a solution that allows users to maintain a persistent avatar across multiple 3D applications and legitimately own all of their cosmetic purchases.

As these digital assets—such as avatars, cosmetic skins, and accessories—become portable and gain significant value, a new and critical technical challenge arises: ensuring their authenticity and enforcing usage policies across different platforms. A technical discontinuity occurs when a visually or functionally equivalent asset is produced without transferring the original asset file. In modern workflows, an output asset may be generated using "indirect evidence" such as rendered imagery, video captures, or descriptive prompts. This process, known as reconstruction-based or "synthetic" transport, breaks traditional governance methods tied to a specific file instance. An unauthorized user could, for example, take a high-resolution screenshot of a rare avatar skin and use an AI tool to reconstruct it, creating a counterfeit asset with no link to the original owner or its usage rights.

### SUMMARY

The present disclosure addresses the aforementioned problems by providing a system and method for managing a portable avatar for a user across multiple 3D rendering platforms. The system enables users to easily customize their avatars using an SDK and API, allowing them to interchange assets for customization at runtime.

In an aspect of the present disclosure, a system for managing an avatar is disclosed. The system comprises a content database configured to store a 3D model of the avatar and associated assets. A content delivery module is coupled with the content database. A Software Development Kit (SDK) module is adaptively integrated with an in-engine avatar customization module of each of the multiple 3D rendering platforms. An Application Programming Interface (API) module communicates with the content delivery module and the SDK module to allow for the utilization of the 3D model of the avatar and its assets at runtime.

In a further aspect, the present disclosure provides a governance framework to ensure identity persistence and policy inheritance for the portable avatars and assets described herein. This framework utilizes a signed, machine-readable Similarity Contract to define similarity metrics and policy requirements for reconstructed assets. When an avatar or asset is reconstructed, a verifiable Derived-Asset Receipt is generated. This receipt provides a cryptographic binding between the original evidence, the reconstruction pipeline, the output asset, and an applicable policy anchor. This receipt is then verified at Enforcement Points within a destination's production tool chain to gate acceptance, compilation, or monetization, thereby preventing the use of unauthorized or non-compliant assets. This governance layer ensures the authenticity and enforces the usage rights of a user's persistent digital avatar and its components as they are utilized across various platforms.

In an aspect, a system for cross-platform delivery and management of a 3D model of an avatar and associated assets is disclosed. The system comprises at least one content delivery module configured to deliver the 3D model of the avatar and associated assets to a plurality of 3D rendering platforms, at least one software development kit (SDK) module configured to interface with an in-engine avatar customization module at a runtime of a 3D rendering platform, at least one multi-application caching module configured to store the 3D model of the avatar and associated assets for reuse across multiple 3D rendering platforms, and at least one content database configured to store the 3D model of the avatar, associated assets, and related metadata.

In an aspect, a computer-implemented method for cross-platform delivery and management of a 3D model of an avatar and associated assets is disclosed. The method comprises delivering, by a content delivery module, the 3D model of the avatar and associated assets to a plurality of 3D rendering platforms. The method further comprises interfacing, by a software development kit (SDK) module, with an in-engine avatar customization module at a runtime of a 3D rendering platform. The method further comprises storing, by a multi-application caching module, the 3D model of the avatar and associated assets for reuse across multiple 3D rendering platforms. The method further comprises storing, in a content database, the 3D model of the avatar, associated assets, and related metadata.

In one or more aspects, the SDK module is configured to fetch one or more second assets utilized by the user for customization of the avatar as available in and by implementation of the corresponding in-engine avatar customization module at the runtime.

In one or more aspects, the multi-application caching module is further configured to consolidate duplicate entries of the avatar and associated assets into a single unified cache entry.

In one or more aspects, the multi-application caching module is further configured to synchronize the unified cache entry with each of the multiple 3D rendering platforms.

In one or more aspects, the multi-application caching module is configured to regularly check for outdated or unused avatar models and assets and remove them from the cache storage.

In one or more aspects, the content database is configured to store metadata associated with each avatar and asset, the metadata comprising at least asset type, asset category, asset creator information, and asset ownership information.

In one or more aspects, the content database supports versioning of avatar assets to enable users to revert to a previous version of the avatar or an asset.

In one or more aspects, the content database includes access control mechanisms comprising at least authentication and encryption to restrict access to avatar data and associated assets.

In one or more aspects, the SDK module is configured to account for differences in how assets are rendered, handled, or animated across different 3D rendering platforms.

In one or more aspects, the method further comprises using a caching mechanism in the content delivery module to store frequently requested 3D models of avatars and assets to reduce access latency.

In one or more aspects, the method further comprises consolidating multiple instances of the same avatar or asset on the user device into a single cache entry using a multi-application caching module.

In one or more aspects, the method further comprises synchronizing a unified cache entry of the avatar and assets across the multiple 3D rendering platforms to maintain consistency.

In one or more aspects, the method further comprises periodically removing unused or outdated avatar models and assets from the user device cache using a multi-application caching module.

In one or more aspects, the method further comprises storing, in the content database, metadata for each avatar and associated asset, the metadata including at least asset type and ownership information.

In one or more aspects, the method further comprises storing multiple versions of an avatar or asset to enable reversion to a prior version.

In one or more aspects, the method further comprises authenticating access to avatar data stored in the content database based on user credentials.

In one or more aspects, the method further comprises adapting the 3D model and associated assets in the SDK module based on specifications of the in-engine avatar customization module.

In one or more aspects, the 3D rendering platforms include at least one of: a video game, a metaverse, or a social virtual reality application, and the user device comprises at least one of: a personal computer, a smartphone, a gaming console, a portable gaming device, a headset, or a heads-up display.

### BRIEF DESCRIPTION OF FIGURES

For a more complete understanding of example embodiments of the present disclosure, reference is now made to the following descriptions taken in connection with the accompanying drawings in which:

FIG. 1 illustrates a diagram of a computing arrangement for implementation of a system for managing an avatar for a user for use in multiple 3D rendering platforms, in accordance with one or more example embodiments of the present disclosure;

FIG. 2 illustrates a diagram of a server, in accordance with one or more example embodiments of the present disclosure;

FIG. 3 illustrates a diagram of a user device, in accordance with one or more example embodiments of the present disclosure;

FIG. 4 illustrates a diagram of a system for managing an avatar for a user for use in multiple 3D rendering platforms, in accordance with one or more example embodiments of the present disclosure;

FIG. 5 illustrates a diagram depicting process flow involved in the system for managing the avatar, in accordance with one or more example embodiments of the present disclosure;

FIG. 6A illustrates an example depiction of a first interface implemented for creating avatar in runtime, in accordance with one or more example embodiments of the present disclosure;

FIG. 6B illustrates an example depiction of a second interface implemented for modelling avatar in runtime, in accordance with one or more example embodiments of the present disclosure;

FIG. 6C illustrates an example depiction of a third interface implemented for customizing avatar in runtime, in accordance with one or more example embodiments of the present disclosure;

FIG. 6D illustrates an example depiction of a fourth interface implemented for finalizing avatar in runtime, in accordance with one or more example embodiments of the present disclosure; and

FIG. 7 illustrates a flowchart listing steps involved in a method for managing avatar for a user, in accordance with one or more example embodiments of the present disclosure.

FIG. 8 illustrates a computing environment for synthetic transport governance including authority services, reconstruction pipelines, destinations, and enforcement points;

FIG. 9 illustrates indirect evidence capture and canonicalization, generating evidence commitments from observational data;

FIG. 10 illustrates a similarity contract data structure including canonicalization rules, metric sets, classification zones, and policy templates;

FIG. 11 illustrates a derived-asset receipt data structure implementing bindings among commitments, classification, and policy anchor, and including freshness and revocation components;

FIG. 12 illustrates a destination acceptance gate flow for repository commit and CI/CD build enforcement;

FIG. 13 illustrates packaging and release signing enforcement using proof-carrying manifests and receipt bundles attached to release manifests;

FIG. 14 illustrates engine import and runtime activation enforcement, including capability restriction and monetization gating;

FIG. 15 illustrates an outsource delivery and payment release gate where acceptance and escrow/holdback release depend on receipt verification;

FIG. 16 illustrates a generator service embodiment that issues receipts bound to pipeline identity and delivers proof-carrying outputs;

FIG. 17 illustrates marketplace listing and settlement enforcement including policy-driven settlement routing and revocation-triggered delisting;

FIG. 18 illustrates protected cluster management and mapping of protected clusters to policy anchors without requiring source UUID knowledge; and

FIG. 19 illustrates selective disclosure verification enabling validation of classification and policy attachment without exposing raw evidence.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

In the following description, for purposes of explanation, numerous specific details are set forth in order to provide a thorough understanding of the present disclosure. It will be apparent, however, to one skilled in the art that the present disclosure is not limited to the specific details described herein.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity but rather denote the presence of at least one of the referenced items. Moreover, various features are described which may be exhibited by some embodiments and not by others. Similarly, various requirements are described which may be requirements for some embodiments but not for other embodiments.

Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Unless specified otherwise in the following description, the terms “perform”, “calculate”, “computer-assisted”, “compute”, “establish”, “generate”, “configure”, “reconstruct”, and the like preferably relate to operations and/or processes and/or processing steps that change and/or generate data and/or convert the data into other data, wherein the data may be represented or be present in particular in the form of physical variables, for example in the form of electrical impulses. The expression “computer” should in particular be interpreted as broadly as possible in order in particular to cover all electronic devices having data processing properties. Computers may thus for example be personal computers, servers, programmable logic controllers (PLCs), hand-held computer systems, pocket PC devices, mobile radio devices and other communication devices able to process data in a computer-assisted manner, processors and other electronic data processing devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Moreover, in particular a person skilled in the art, with knowledge of the disclosed techniques, is aware of all routine possibilities for realizing products or possibilities for implementation in the prior art, and so there is no need in particular for independent disclosure in the description. In particular, these customary realization variants known to the person skilled in the art can be realized exclusively by hardware components or exclusively by software components. Alternatively, and/or additionally, the person skilled in the art, within the scope of his/her expert ability, can choose to the greatest possible extent arbitrary combinations according to embodiments of the invention for hardware components and software components in order to implement realization variants according to embodiments of the invention.

Some portions of the detailed description that follows are presented and discussed in terms of a process or method. Although steps and sequencing thereof are disclosed in figures herein describing the operations of this method, such steps and sequencing are examples. Embodiments are well suited to performing various other steps or variations of the steps recited in the flowchart of the figure herein, and in a sequence other than that depicted and described herein. Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. In present implementations, the language used for training may be, e.g., Python, Tensorflow, Bazel, C, or C++. Further, decoder in user device (as will be discussed) may use C, C++ or any processor specific ISA. Furthermore, assembly code inside C/C++ may be utilized for specific operation. Also, ASR (automatic speech recognition) and G2P decoder along with entire user system can be run in embedded Linux® (any distribution), Android®, iOS®, Windows®, or the like, without any limitations. The program code may be executed entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures. For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

In one aspect, this disclosure provides a computer-implemented governance layer that treats reconstruction-based creation as a transport protocol, binds policy obligations to reconstructed avatars and assets, and enforces those obligations at critical pipeline interfaces, such as a game engine's import gate or a marketplace's listing system.

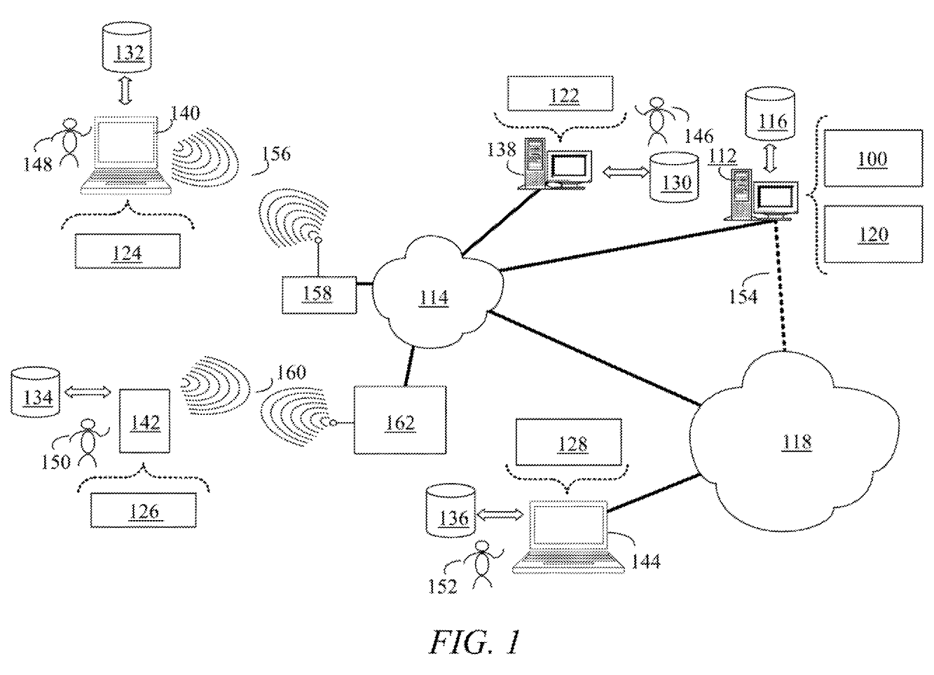

Referring to example implementation of FIG. 1, there is shown a computing arrangement 100 that may reside on and may be executed by a computer (e.g., computer 112), which may be connected to a network (e.g., network 114) (e.g., the internet or a local area network). Examples of computer 112 may include, but are not limited to, a personal computer(s), a laptop computer(s), mobile computing device(s), a server computer, a series of server computers, a mainframe computer(s), or a computing cloud(s). In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 112 may execute an operating system, for example, but not limited to Microsoft Windows®; Mac OS X®; Red Hat Linux®, or a custom operating system.

In some implementations, the instruction sets and subroutines of computing arrangement 100, which may be stored on storage devices, such as storage device 116, coupled to computer 112, may be executed by one or more processors (not shown) and one or more memory architectures included within computer 112. In some implementations, storage device 116 may include but is not limited to: a hard disk drive; a flash drive, a tape drive; an optical drive; a RAID array (or other array); a random-access memory (RAM); and a read-only memory (ROM).

In some implementations, network 114 may be connected to one or more secondary networks (e.g., network 118), examples of which may include but are not limited to: a local area network; a wide area network; or an intranet, for example.

In some implementations, computer 112 may include a data store, such as a database (e.g., relational database, object-oriented database, triplestore database, etc.) and may be located within any suitable memory location, such as storage device 116 coupled to computer 112. In some implementations, data, metadata, information, etc. described throughout the present disclosure may be stored in the data store. In some implementations, computer 112 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, computing arrangement 100 may be a component of the data store, a standalone application that interfaces with the above noted data store and/or an applet/application that is accessed via client applications 122, 124, 126, 128. In some implementations, the above noted data store may be, in whole or in part, distributed in a cloud computing topology. In this way, computer 112 and storage device 116 may refer to multiple devices, which may also be distributed throughout the network.

In some implementations, computer 112 may execute application 120 for managing an avatar for a user for use in multiple 3D rendering platforms. In some implementations, computing arrangement 100 and/or application 120 may be accessed via one or more of client applications 122, 124, 126, 128. In some implementations, computing arrangement 100 may be a standalone application, or may be an applet/application/script/extension that may interact with and/or be executed within application 120, a component of application 120, and/or one or more of client applications 122, 124, 126, 128. In some implementations, application 120 may be a standalone application, or may be an applet/application/script/extension that may interact with and/or be executed within computing arrangement 100, a component of computing arrangement 100, and/or one or more of client applications 122, 124, 126, 128. In some implementations, one or more of the client applications 122, 124, 126, 128 may be a standalone application, or may be an applet/application/script/extension that may interact with and/or be executed within and/or be a component of computing arrangement 100 and/or application 120. Examples of client applications 122, 124, 126, 128 may include, but are not limited to, a standard and/or mobile web browser, an email application (e.g., an email client application), a textual and/or a graphical user interface, a customized web browser, a plugin, an Application Programming Interface (API), or a custom application. The instruction sets and subroutines of client applications 122, 124, 126, 128, which may be stored on storage devices 130, 132, 134, 136, coupled to user devices 138, 140, 142, 144, may be executed by one or more processors and one or more memory architectures incorporated into user devices 138, 140, 142, 144.

In some implementations, one or more of the storage devices 130, 132, 134, 136, may include but are not limited to: hard disk drives; flash drives, tape drives; optical drives; RAID arrays; random access memories (RAM); and read-only memories (ROM). Examples of user devices 138, 140, 142, 144 (and/or computer 112) may include, but are not limited to, a personal computer (e.g., user device 138), a laptop computer (e.g., user device 140), a smart/data-enabled, cellular phone (e.g., user device 142), a notebook computer (e.g., user device 144), a tablet (not shown), a server (not shown), a television (not shown), a smart television (not shown), a media (e.g., video, photo, etc.) capturing device (not shown), and a dedicated network device (not shown). User devices 138, 140, 142, 144 may each execute an operating system, examples of which may include but are not limited to Android, Apple IOS, Mac OS X; Red Hat Linux, or a custom operating system.

In some implementations, one or more of client applications 122, 124, 126, 128 may be configured to effectuate some or all of the functionality of computing arrangement 100 (and vice versa). Accordingly, in some implementations, computing arrangement 100 may be a purely server-side application, a purely client-side application, or a hybrid server-side/client-side application that is cooperatively executed by one or more of the client applications 122, 124, 126, 128 and/or computing arrangement 100.

In some implementations, one or more of client applications 122, 124, 126, 128 may be configured to effectuate some or all of the functionality of application 120 (and vice versa). Accordingly, in some implementations, application 120 may be a purely server-side application, a purely client-side application, or a hybrid server-side/client-side application that is cooperatively executed by one or more of client applications 122, 124, 126, 128 and/or application 120. As one or more of client applications 122, 124, 126, 128, computing arrangement 100, and application 120, taken singly or in any combination, may effectuate some or all of the same functionality, any description of effectuating such functionality via one or more of client applications 122, 124, 126, 128, computing arrangement 100, application 120, or combination thereof, and any described interaction(s) between one or more of client applications 122, 124, 126, 128, computing arrangement 100, application 120, or combination thereof to effectuate such functionality, should be taken as an example only and not to limit the scope of the disclosure.

In some implementations, one or more of the users 146, 148, 150, 152 may access computer 112 and computing arrangement 100 (e.g., using one or more of user devices 138, 140, 142, 144) directly through network 114 or through secondary network 118. Further, computer 112 may be connected to network 114 through secondary network 118, as illustrated with phantom link line 154. Computing arrangement 100 may include one or more user interfaces, such as browsers and textual or graphical user interfaces, through which users 146, 148, 150, 152 may access computing arrangement 100.

In some implementations, the various user devices may be directly or indirectly coupled to communication network, such as communication network 114 and communication network 118, hereinafter simply referred to as network 114 and network 118, respectively. For example, user device 138 is shown directly coupled to network 114 via a hardwired network connection. Further, user device 144 is shown directly coupled to network 118 via a hardwired network connection. User device 140 is shown wirelessly coupled to network 114 via wireless communication channel 156 established between user device 140 and wireless access point (i.e., WAP) 158, which is shown directly coupled to network 114. WAP 158 may be, for example, an IEEE 802.11a, 802.11b, 802.11g, Wi-Fi, RFID, and/or Bluetooth (including Bluetooth Low Energy) device that is capable of establishing wireless communication channel 156 between user device 140 and WAP 158. User device 142 is shown wirelessly coupled to network 114 via wireless communication channel 160 established between user device 142 and cellular network/bridge 162, which is shown directly coupled to network 114.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example, Bluetooth (including Bluetooth Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

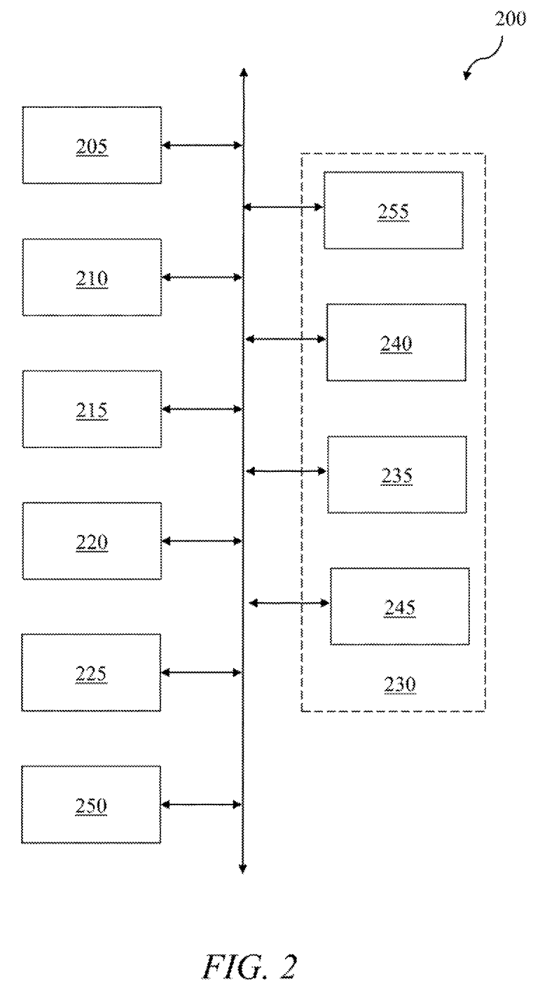

The computing arrangement 100 may include a server (such as server 200, as shown in FIG. 2) for managing an avatar for a user for use in multiple 3D rendering platforms. In the present implementations, the computing arrangement 100 itself may be embodied as the server 200. Herein, FIG. 2 is a block diagram of an example of server 200 capable of implementing embodiments according to the present disclosure. In the example of FIG. 2, the server 200 may include a processing unit 205 for running software applications (such as, the application 120 of FIG. 1) and optionally an operating system. As illustrated, the server 200 may further include a database 210 which stores applications and data for use by the processing unit 205. Storage 215 provides non-volatile storage for applications and data and may include fixed disk drives, removable disk drives, flash memory devices, CD-ROM, DVD-ROM or other optical storage devices. An optional user input device 220 may include devices that communicate user inputs from one or more users to the server 200 and may include keyboards, mice, joysticks, touch screens, etc. A communication or network interface 225 is provided which allows the server 200 to communicate with other computer systems via an electronic communications network, including wired and/or wireless communication and including an Intranet or the Internet. In one embodiment, server 200 receives instructions and user inputs from a remote computer through communication interface 225. Communication interface 225 can comprise a transmitter and receiver for communicating with remote devices. An optional display device 250 may be provided which can be any device capable of displaying visual information in response to a signal from server 200. The components of the server 200, including the processing unit 205, the database 210, the data storage 215, the user input devices 220, the communication interface 225, and the display device 250, may be coupled via one or more data buses, such as data bus 260.

In the embodiment of FIG. 2, a graphics system 230 may be coupled with the data bus 260 and the components of the server 200. The graphics system 230 may include a physical graphics processing arrangement (GPU) 235 and graphics memory. The GPU 235 generates pixel data for output images from rendering commands. The physical GPU 235 can be configured as multiple virtual GPUs that may be used in parallel (concurrently) by a number of applications or processes executing in parallel. For example, mass scaling processes for rigid bodies or a variety of constraint solving processes may be run in parallel on the multiple virtual GPUs. Graphics memory may include a display memory 240 (e.g., a framebuffer) used for storing pixel data for each pixel of an output image. In another embodiment, the display memory 240 and/or additional memory 245 may be part of the database 210 and may be shared with the processing unit 205. Alternatively, the display memory 240 and/or additional memory 245 can be one or more separate memories provided for the exclusive use of the graphics system 230. In another embodiment, the graphics system 230 may include one or more additional physical GPUs 255, similar to the GPU 235. Each additional GPU 255 may be adapted to operate in parallel with the GPU 235. Each additional GPU 255 generates pixel data for output images from rendering commands. Each additional physical GPU 255 can be configured as multiple virtual GPUs that may be used in parallel (concurrently) by a number of applications or processes executing in parallel, e.g., processes that solve constraints. Each additional GPU 255 can operate in conjunction with the GPU 235, for example, to simultaneously generate pixel data for different portions of an output image, or to simultaneously generate pixel data for different output images. Each additional GPU 255 can be located on the same circuit board as the GPU 235, sharing a connection with the GPU 235 to the data bus 260, or each additional GPU 255 can be located on another circuit board separately coupled with the data bus 260. Each additional GPU 255 can also be integrated into the same module or chip package as the GPU 235. Each additional GPU 255 can have additional memory, similar to the display memory 240 and additional memory 245, or can share the memories 240 and 245 with the GPU 235. It is to be understood that the circuits and/or functionality of GPU as described herein could also be implemented in other types of processors, such as general-purpose or other special-purpose coprocessors, or within a CPU.

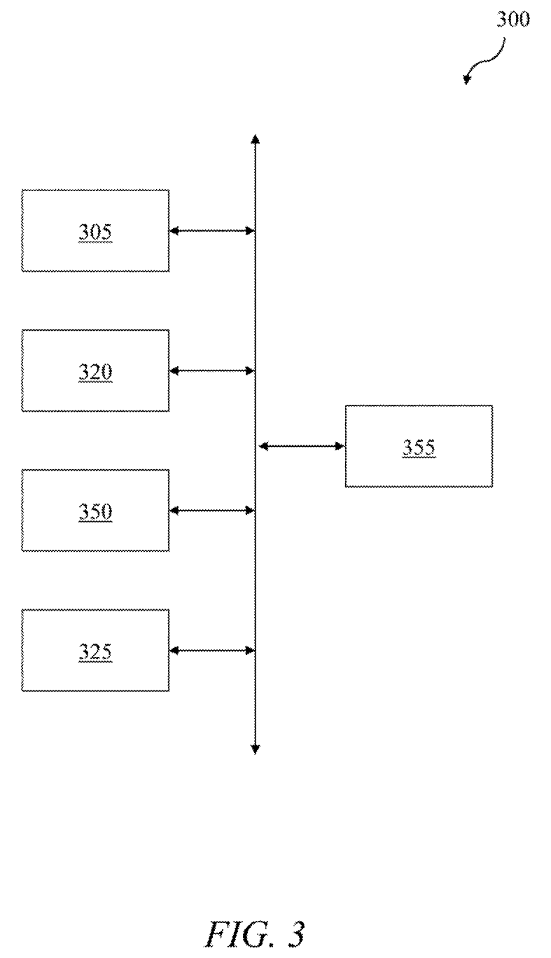

The computing arrangement 100 may also include a user device 300 (as shown in FIG. 3). In embodiments of the present disclosure, the user device 300 may embody a smartphone, a personal computer, a tablet, or the like. Herein, FIG. 3 is a block diagram of an example of the user device 300 capable of implementing embodiments according to the present disclosure. In the example of FIG. 3, the user device 300 may include a processor 305 (hereinafter, referred to as a CPU) for running software applications (such as the application 120 of FIG. 1) and optionally an operating system. A user input device 320 is provided which may include devices that communicates user inputs from one or more users and may include keyboards, mice, joysticks, touch screens, and/or microphones. Further, a network adapter 325 is provided which allows the user device 300 to communicate with other computer systems (e.g., the server 200 of FIG. 2) via an electronic communications network, including wired and/or wireless communication and including the Internet. The user device 300 may also include a decoder 355 may be any device capable of decoding (decompressing) data that may be encoded (compressed). A display device 350 may be provided which may be any device capable of displaying visual information, including information received from decoder 355. In particular, as will be described below, the display device 350 may provide an interface, such that the display device 350 is configured to display information received from the server 200 of FIG. 2. The components of the user device 300 may be coupled via one or more data buses 360.

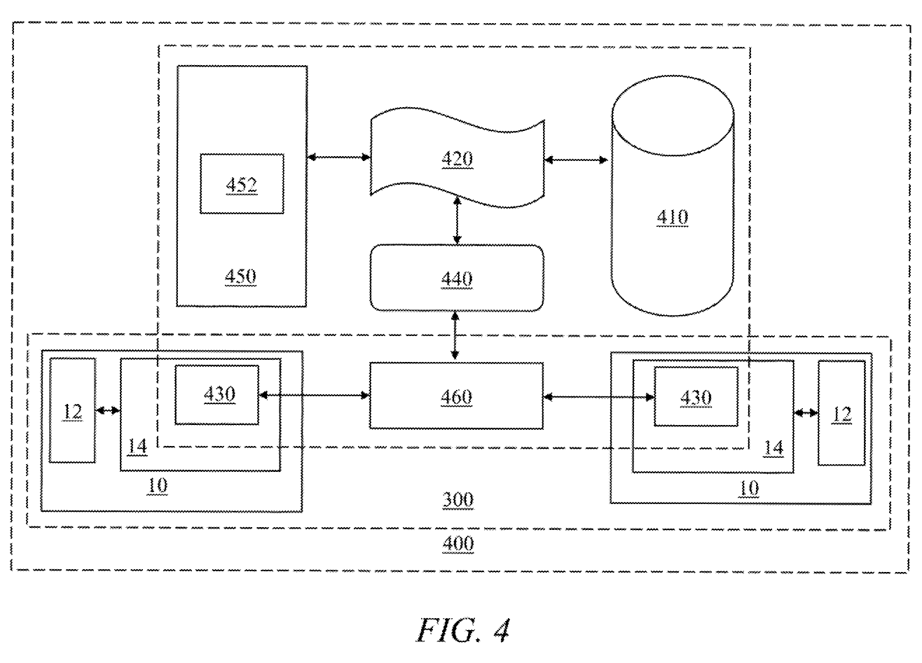

Referring to FIG. 4, illustrated is an example block diagram of a system 400 for managing an avatar for a user for use in multiple 3D rendering platforms (as represented by reference numeral 10). The system 400, as described in the present disclosure, is integrated within computing arrangement 100, and may be specifically implemented in the user device 300 in combination with (or without) the server 200 of the computing arrangement 100. Herein, the server 200 may manage and coordinate the necessary data, processing, and communication involved in the proper functioning of the system 400. Simultaneously, the user device 300 may serve as an interactive interface for users to engage with the system 400, offering customization options, access to assets, and seamless interaction with the multiple real-time 3D rendering platforms. By implementing the system 400 within the server 200 and the user device 300, the present invention ensures a comprehensive and coherent framework for creating and customizing avatars, as well as providing a consistent user experience across various games, metaverses, or any other real-time 3D rendered environments.

In context of the present disclosure, the 3D rendering platforms 10 refer to various interactive digital environments that utilize real-time 3D graphics to display and navigate within their respective virtual worlds. The 3D rendering platforms 10 cater to different audiences and purposes, creating diverse experiences that rely on 3D graphics technology for realistic and engaging interactions. In present examples, the 3D rendering platforms 10 may be real-time rendering platforms, in which the real-time aspect signifies that the graphical content is continuously rendered and updated based on user interactions, ensuring a responsive and dynamic experience. Real-time 3D graphics technology enables the rendering of 3D scenes, objects, and characters with rapid updates based on user inputs or changing conditions within the virtual environment. Such technology relies on sophisticated algorithms and hardware acceleration to achieve smooth and fluid visuals, allowing users to experience an immersive, dynamic, and interactive environment.

Specifically, in embodiments of the present disclosure, the 3D rendering platforms 10 include those platforms that provide an avatar for the user, allowing the users to represent themselves within the virtual environment. As used herein, an avatar is a customizable digital representation of the user within the virtual environment. The avatar may take various forms, ranging from human-like characters to fantastical creatures or abstract entities, depending on the specific platform and user preferences. The avatar serves as the user's digital identity, allowing them to interact with other users and the virtual environment. The objective of the present disclosure is to enable users to maintain a consistent and persistent avatar across these diverse platforms, enhancing their experience and digital identity. The system 400 of the present disclosure aims to manage the avatars for the user, so that these avatars may be used across various 3D rendering platforms 10, allowing users to maintain a consistent and persistent digital identity throughout their online experiences.

For purposes of the present disclosure, the multiple 3D rendering platforms 10 encompass a wide range of interactive digital environments, including video games, metaverses, and social virtual reality applications. Video games are interactive entertainment experiences that involve real-time 3D graphics to create immersive environments for players to navigate and engage with. They can span various genres, such as role-playing games (RPGs), first-person shooters (FPS), and massively multiplayer online games (MMOs). Metaverses are expansive, interconnected virtual worlds that allow users to explore, socialize, and participate in various activities. These digital spaces provide a platform for users to create and customize their own avatars, build virtual environments, and interact with other users in real-time. Metaverses can be used for a wide range of purposes, including entertainment, education, social networking, c-commerce, and collaborative workspaces. Social virtual reality applications are platforms that utilize virtual reality (VR) technology to create immersive social experiences for users. These applications enable users to interact with others in a shared virtual environment, using avatars as their digital representations. In each of these 3D rendering platforms, avatars play a critical role in representing users and enabling them to interact within the virtual environment.

As may be contemplated, each one of the multiple 3D rendering platforms 10 may include a 3D game engine module (as represented by reference numeral 12) configured to render the avatar in runtime. The 3D game engine module 12 is a software framework designed for the development and execution of interactive 3D applications, such as video games, simulations, and virtual environments. The 3D game engine module 12 provides a range of tools and functionalities, including rendering, physics, animation, and artificial intelligence, that enable developers to create immersive and interactive experiences. Rendering is the process of converting the digital representation of an avatar, including its geometry, textures, and animations, into a visually coherent form that can be displayed on the user's device. As used herein, runtime refers to the period during which a 3D application or game is actively executing and being interacted with by the user. In contrast to the development phase, where assets and functionalities are being created and integrated, runtime encompasses the actual experience of the user as they navigate and interact within the 3D environment.

Herein, the 3D game engine module 12 may include at least one of the following popular and widely used game engines, such as Unity Engine®, Unreal Engine®, Godot Engine® CryEngine®. Each of these game engines offers unique capabilities and advantages, and the present disclosure may be implemented using any one or a combination of these engines to create a seamless and persistent avatar experience across the multiple 3D rendering platforms 10. By leveraging the capabilities of the 3D game engine module 12, the avatar can be rendered in real-time, allowing for smooth and responsive interaction with the virtual environment and other users. In addition to rendering the avatar, the 3D game engine module 12 may also manage other aspects of the avatar's behavior and appearance during runtime, such as handling animation, collision detection, and physics interactions. This ensures that the user's avatar behaves and reacts realistically within the context of the 3D rendering platform 10, providing a seamless and immersive experience.

Further, each one of the multiple 3D rendering platforms 10 may include an in-engine avatar customization module (as represented by reference numeral 14) to allow the user to interchange assets for customization of the avatar at the runtime. That is, the in-engine avatar customization module 14 enables the users to seamlessly interchange and modify assets of their avatar in real-time while they are using the 3D rendering platforms 10. The in-engine avatar customization module 14 allows for a more dynamic and personalized experience by providing users with the ability to make adjustments to their avatars without having to leave the platform or restart the application. By offering these customization options and more within the 3D rendering platforms 10, the in-engine avatar customization module 14 significantly enhances the user experience, promoting a deeper sense of identity and personalization within the digital world.

As used herein, the assets refer to a wide range of customizable elements or components that users can apply to their avatars in order to personalize and enhance their digital personas. These assets helps in creating a unique and distinctive appearance for each user's avatar, contributing to a more immersive and engaging experience across the 3D rendering platforms 10. The assets may encompass a diverse array of customizable elements, including separate layers of clothing including shirt, t-shirt, pants, over-jacket; facial features; hair texture; hair color; eyeglasses; make-up features; mask; hat; jewelry; shoes; gloves; music. The separate layers of clothing such as shirts, t-shirts, pants, and over-jackets allow users to mix and match different styles and outfits and can be layered on top of each other. Additionally, users can modify facial features to create a desired expression or resemblance, while hair texture and color options provide further customization possibilities. Accessories such as eye-glasses, make-up features, masks, hats, and jewelry can be added or removed to give the avatar a unique look. Further, users can choose from a variety of shoes and gloves to complete their avatars' outfits. Furthermore, music can serve as an audio asset that adds a personal touch to the user's digital persona. Users can select a specific track, melody, or sound effect to accompany their avatar, creating a unique auditory signature that reflects their taste and style. By providing a comprehensive selection of assets, the present invention enables users to tailor their digital identities to their personal preferences, fostering a greater sense of individuality and self-expression within the virtual worlds of 3D rendering platforms.

As discussed, the in-engine avatar customization module 14 offers users the ability to effortlessly interchange and modify their avatars' assets in real-time as they engage with the 3D rendering platforms 10. Swapping outfits is one example, as users within a metaverse or virtual social space may wish to alter their avatars' clothing to suit a specific theme or event. The in-engine avatar customization module 14 facilitates easy transitions between various outfits or clothing pieces, rendering avatars readily adaptable to diverse situations. Additionally, the in-engine avatar customization module 14 permits users to adjust facial features to convey a particular emotion or more accurately reflect their real-life appearance, thereby enhancing the authenticity and personal connection with their digital personas. Accessory customization is another feature of the in-engine avatar customization module 14, enabling users to add or remove items such as hats, glasses, or jewelry for an added layer of personalization. Users can conveniently experiment with a range of accessory combinations to achieve their desired look or style. Changing hairstyles is also made possible through the in-engine avatar customization module 14, allowing users to modify their avatars' hairstyles to suit their preferences or to align with a specific event or theme, all without leaving the 3D rendering platform 10. Lastly, the in-engine avatar customization module 14 may incorporate in-game items, wearables, or assets acquired within a specific game or platform into the user's avatar. This functionality enables users to display their in-game achievements or purchases across multiple 3D rendering platforms 10.

In present examples, the 3D rendering platforms 10 may be executed in a user device (such as, the user device 300). That is, these 3D rendering platforms 10 can be accessed by users through their user devices 300, which encompass a wide range of hardware and form factors to provide versatile and convenient access to the virtual worlds. For purposes of the present disclosure, the user device 300 may include various types of hardware that allow users to access and interact with the 3D rendering platforms 10. In present embodiments, the user device 300 may include at least one of: a personal computer, a smartphone, a gaming console, a portable gaming device, a headset, and a heads-up display. Herein, a personal computer, for example, can be a desktop or laptop computer that enables users to run gaming applications, virtual worlds, or metaverse platforms, providing a wide range of customization and interaction options through peripherals such as a keyboard, mouse, or gaming controllers. A smartphone, on the other hand, offers a portable and convenient way for users to access these platforms through mobile applications, utilizing touch-based controls and built-in sensors for interaction. Gaming consoles, such as PlayStation®, Xbox®, or Nintendo Switch®, provide a dedicated platform for gaming experiences, including online multiplayer games and social virtual worlds, often with specialized controllers for intuitive input. Portable gaming devices, like the Nintendo Switch Lite or PlayStation Vita, combine the convenience of a mobile device with dedicated gaming hardware, allowing users to engage with their avatars on-the-go. Headsets, such as VR or augmented reality (AR) devices, immerse users in the virtual environment, providing an even more immersive and intuitive experience through natural movements and gestures. Finally, heads-up displays, like Google Glass or other smart glasses, overlay digital information onto the user's view of the real world, enabling seamless integration between the virtual and physical realms. Each of these user devices 300 allows users to interact with their avatars across the said multiple 3D rendering platforms 10.

According to an embodiment, as illustrated in FIG. 4, the system 400 of the present disclosure includes a content database 410 configured to store a 3D model of the avatar and one or more assets associated with the 3D model of the avatar, as available with the user; a content delivery module 420 communicatively coupled with the content database 410, and configured to fetch the avatar and the assets from the content database 410 and deliver data; a SDK module 430 adapted to be integrated with the in-engine avatar customization module 14 of each one of the multiple 3D rendering platforms 10, and configured to allow for utilization of the said 3D model of the avatar and at least one of the said one or more assets compatible with the corresponding in-engine avatar customization module at the runtime, for the user to customize the avatar by implementing the said corresponding in-engine avatar customization module; and an API module 440 in communication with the content delivery module 420 and the SDK module 430, and configured to process requests from the SDK module 430 for avatar and asset data from the content database 410 via the content delivery module 420.

In particular, the content database 410 is designed to store and manage the 3D models of avatars along with one or more assets associated with each respective 3D model of the avatar. The content database 410 ensures that the user's avatar and associated assets are readily available for use across various real-time 3D rendering platforms 10. By housing the 3D models of user avatars and their associated assets in a centralized location, the content database 410 enables efficient data management and retrieval, facilitating seamless access and interaction with the avatars across multiple 3D rendering platforms 10. The content database 410 may also ensure that user avatars and associated assets are compatible with different real-time 3D rendering platforms 10. Metadata associated with each avatar and asset may also be stored in the content database 410. This metadata may include, but is not limited to, asset type, asset category, asset creator information, and asset ownership information.

In some examples, the content database 410 may also support versioning for avatars and assets, enabling users to maintain multiple versions of their avatar or individual assets. This feature allows users to revert to a previous version of their avatar or asset if desired, providing an additional level of customization and control. In some examples, the content database 410 may be configured with appropriate access control mechanisms, ensuring that users can access and modify their own avatars and associated assets, and optionally only their own avatars and associated assets. These access controls may include authentication, authorization, and encryption techniques to protect user data and maintain privacy. The content database 410 may also be structured in a hierarchical manner, with each user's avatar and its associated assets grouped together. The content database 410 may utilize a scalable and efficient storage system that can accommodate the growing number of avatars and associated assets. Such storage system may employ a combination of relational databases, NoSQL databases, and/or distributed file systems to ensure the optimal organization and retrieval of data. To further enhance the performance of the content database, various optimization techniques may be employed, such as caching, indexing, and load balancing. These techniques help ensure that the content database can efficiently serve avatars and assets to users across multiple real-time 3D rendering platforms, even under high-traffic conditions.

The SDK module 430 enables the integration and seamless interoperability of the in-engine avatar customization module 14 across the multiple 3D rendering platforms 10. The SDK module 430 provides developers with the necessary tools, libraries, and guidelines to implement the system's functionalities within the respective 3D rendering platforms 10. Specifically, the SDK module 430 facilitates the utilization of the 3D model of the avatar and at least one of the assets stored in the content database 410, ensuring compatibility with the corresponding in-engine avatar customization module 14. By integrating the SDK module 430 into the 3D rendering platforms 10, developers can enable users to customize their avatars using the available assets (and any additional second assets, as discussed later in the description) in real-time, during runtime of the corresponding 3D rendering platform 10. Thus, the SDK module 430 serves as a link in the system 400, bridging the gap between the content database 410, and the in-engine avatar customization module 14 and the multiple 3D rendering platforms 10.

It may be understood that the SDK module 430 takes into consideration the unique requirements and specifications of the corresponding in-engine avatar customization module 14 when allowing for the utilization of the 3D model of the avatar and at least one of the assets. This involves converting or adapting the 3D model and assets into a format that can be readily understood and processed by the in-engine avatar customization module. The SDK module 430 may also account for any differences in the way assets are handled, rendered, or animated across different 3D rendering platforms 10, ensuring that the avatar and associated assets maintain their intended appearance and functionality regardless of the 3D rendering platform 10. It may also be appreciated that in addition to providing compatibility between with the multiple 3D rendering platforms 10, the SDK module 430 may also help maintain a consistent user experience. The SDK module 430 ensures that the avatar customization features are accessible and function similarly across different 3D rendering platforms 10, thereby allowing the users to modify their avatars quickly and easily without encountering platform-specific limitations or discrepancies. Furthermore, the SDK module enables developers to add or update avatar assets, customization options, and other features as needed, ensuring that the system 400 remains adaptable and up to date with evolving user preferences and industry trends.

The API module 440 facilitates seamless communication between various components, such as the content delivery module 420, the SDK module 430, and other integrated services in the system 400. By providing a standardized set of protocols, conventions, and functions, the API module 440 ensures that different parts of the system 400 can efficiently exchange information and work together harmoniously. Specifically, herein, the API module 440 is configured to receive a request from the SDK module 430 for specific resources, such as the 3D model of the avatar and the associated assets. Upon receiving the request, the API module 440 processes the request and communicates with the content delivery module 420 to retrieve the requested data. After acquiring the necessary information, the API module 440 sends the data back to the SDK module 430, which in turn utilizes the data to customize and render the avatar within the corresponding 3D rendering platform 10. It may be appreciated that, additionally, the API module 440 may also serve as an abstraction layer in the system 400, shielding the internal workings of the system 400 and providing a simplified interface for developers to work with. This allows developers to focus on building and customizing their avatars and assets without needing to delve into the intricacies of underlying architecture the system 400.

The content delivery module 420 is responsible for the efficient retrieval and delivery of the 3D model of the avatar and the associated assets from the content database 410 to the SDK module 430. The content delivery module 420 facilitates seamless communication between the content database 410 and the SDK module 430, ensuring that the necessary avatar and asset data are readily available for customization and rendering within the various 3D rendering platforms. Specifically, the content delivery module 420 processes the incoming request from the API module 440, queries the content database 410, and retrieves the relevant data. The integration of the content delivery module 420 within the present system 400 helps to maintain a seamless and efficient workflow between the content database 410, the API module 440, and the SDK module 430. By working in tandem with these other components, the content delivery module 420 allows users to access and customize their avatars and assets with minimal delays, regardless of their specific 3D rendering platform 10 or the user device 300.

In addition to its primary function of fetching and delivering the 3D model of the avatar and the assets, the content delivery module 420 may also serve a broader role in optimizing the performance and user experience within the system 400. The content delivery module 420 may employ various caching mechanisms and strategies to minimize latency, reduce bandwidth consumption, and ensure the timely delivery of content. For instance, to improve performance and reduce response times, the content delivery module 420 may incorporate a caching mechanism which stores frequently requested avatar models and assets in a cache, thereby minimizing the need for repetitive database queries and speeding up content delivery. To handle varying levels of demand and ensure optimal performance, the content delivery module 420 may include a load balancing component, which distributes incoming requests across multiple instances of the content delivery module 420, ensuring that no single instance becomes overwhelmed with traffic. To protect the integrity of the content and prevent unauthorized access, the content delivery module 420 may also incorporate security and authentication mechanisms, which validate incoming requests, verify user credentials, and apply encryption to the content as necessary.

The content delivery module 420 may also leverage advanced algorithms and techniques to prioritize and manage the delivery of assets based on factors such as network conditions, user location, and device capabilities. This ensures that the user experience remains consistent and responsive, even in situations where network connectivity or device performance may be less than optimal. In an embodiment, the content delivery module 420 utilizes a Content Delivery Network (CDN) to further optimize the retrieval and distribution of the 3D model of the avatar and the associated assets to user devices 300 across various 3D rendering platforms 10. A CDN is a globally distributed network of servers that work together to provide fast and efficient delivery of content to users based on their geographical location and proximity to the CDN servers. By leveraging the geographical distribution of CDN servers, the content delivery module 420 can deliver the 3D model of the avatar and the assets from a server that is closer to the user's location, resulting in reduced latency and faster response times. The CDN may further improve reliability by distributing content across multiple servers and locations, ensuring that the 3D model of the avatar and the assets remain available and accessible even in the event of server outages or network disruptions. Further, as the number of users and the demand for content increases, the CDN can easily scale to accommodate the growing traffic without compromising the performance of the content delivery module 420, and thereby the overall system 400.

In operation of the present system 400, when the user initiates a customization request, the SDK module 430 communicates with the API module 440, sending a first request for the 3D model of the avatar and first assets. Herein, the term “first assets” refers to the initial set of digital items, features, or components associated with a user's avatar within the content database 410. That is, the first assets are the pre-existing assets available to a user when they first create or customize their avatar within a specific 3D rendering platform 10. These first assets are directly linked to the 3D model of the avatar and may include various customization options such as clothing, facial features, hair textures and colors, accessories, and more. Further, the term “first request” refers to the initial communication initiated by the SDK module 430 to the API module 440 when the user wishes to access and utilize these first assets for avatar customization. Upon receiving the first request from the SDK module 430, the API module 440 forwards the first request to the content delivery module 420. The content delivery module 420 is responsible for fetching the requested 3D model of the avatar and the first assets from the content database 410. The content delivery module 420 efficiently retrieves the requested content, leveraging caching mechanisms and the CDN, if required, to ensure optimal performance and quick response times. Once the content delivery module 420 has fetched the 3D model of the avatar and the relevant first assets from the content database 410, the content delivery module 420 delivers this data back to the SDK module 430. The SDK module 430 then integrates the fetched content with the in-engine avatar customization module 14, enabling the user to seamlessly customize their avatar in real-time within the 3D rendering platform 10. This streamlined process ensures that users can effortlessly personalize their avatars across multiple 3D rendering platforms 10, fostering a more engaging and immersive experience for users as they interact within various virtual environments.

In some scenarios, the user may acquire new customization assets, referred to as “second assets,” while using the 3D rendering platforms 10. These second assets may include additional clothing, accessories, or other personalization elements that the user obtains through in-platform achievements, purchases, or other means. To ensure that these newly acquired assets are accessible for future avatar customization, the system 400 allows to save these second assets in the content database 410. For this purpose, the SDK module 430 is further configured to fetch one or more second assets utilized by the user for customization of the avatar as available in and by implementation of the said corresponding in-engine avatar customization module 14 at the runtime. That is, the SDK module 430, integrated with the in-engine avatar customization module 14 of the 3D rendering platform 10, detects the user's utilization of the newly acquired second assets at runtime. The SDK module 430 then retrieves these second assets from the in-engine avatar customization module 14. Also, the API module 440 is further configured to receive a second request from the SDK module 430 for the said one or more second assets for storage in the content database 410. That is, once the second assets are fetched, the SDK module 430 sends a second request to the API module 440. This second request may contain the acquired second assets and may indicate that they should be stored in the content database 410. Further, the content delivery module 420 is further configured to fetch the said one or more second assets from the SDK module 430 in response to the said second request at the API module 440. That is, in response to the second request received at the API module 440, the content delivery module 420 retrieves the second assets from the SDK module 430. This ensures that the content delivery module 420 has access to the new assets for subsequent storage and distribution. Furthermore, the content database 410 is configured to store the said one or more second assets therein. That is, after retrieving the second assets from the SDK module 430, the content delivery module 420 stores them in the content database 410. This allows users to access and utilize the new assets for future avatar customization across the multiple 3D rendering platforms 10. By implementing this process, the system 400 ensures that users' newly acquired assets (i.e., second assets) are saved to be readily available for use in future avatar customization sessions.

According to one or more embodiments, as illustrated in FIG. 4, the system 400 may further include a user account module 450 for recording ownership of the avatar and associated assets for the user. Herein, the user account module 450 records the ownership of the user's 3D avatar model, the initial first assets, and any additional second assets. This ensures that the system 400 accurately tracks digital belongings of the user and enables a smooth and secure user experience across the multiple 3D rendering platforms 10. For this purpose, when a user may first register in the system 400, the user account module 450 creates a unique account for such user, which stores the user's avatar, first assets, and any subsequently acquired second assets. The user account module 450, in conjunction with other components of the system 400 such as the content database 410, ensures that user has access to their avatars and associated assets across the multiple 3D rendering platforms 10. This feature enables a consistent and personalized user experience, regardless of the 3D rendering platform 10 being used.

In an embodiment, the user account module 450 is configured to implement a distributed ledger 452 for recording the ownership of the 3D model of the avatar, the one or more first assets and the one or more second assets for the user. That is, the user account module 450 may implement the distributed ledger 452, such as a blockchain, to provide a secure and transparent method of tracking asset ownership. It may be contemplated by a person skilled in the art that these records may be stored in the distributed ledger 452 to provide a clear and immutable history of each user's digital belongings. This technology ensures that the ownership records are tamper-resistant and easily verifiable, enhancing trust in the system 400. The distributed ledger 452 implemented by the user account module 450 further enables secure and transparent asset transfers between users, such as trading or gifting avatar customization items. Thereby, the user account module 450 is able to track these transactions and updates the ownership records accordingly.

Also, as illustrated in FIG. 4, the system 400 may further include a multi-application caching module 460 for deleting duplicate entries of the 3D model of the avatar and associated assets between the multiple 3D rendering platforms 10 in the user device 300. That is, the system 400 may also incorporate the multi-application caching module 460 designed to optimize the storage and management of the 3D avatar model and its associated assets in the user device 300 when accessed across multiple 3D rendering platforms 10. For this purpose, the multi-application caching module 460 may continuously monitor the cache storage on the user device 300, identifying instances where the 3D avatar model and associated assets are being duplicated across different 3D rendering platforms 10. Upon detecting duplicate entries, the multi-application caching module 460 consolidates them into a single, unified cache entry. This process ensures that one instance, and optionally only one instance, of the 3D avatar model and its related assets are stored on the user device 300, regardless of the number of the 3D rendering platforms 10 being used. Further, the multi-application caching module 460 synchronizes the unified cache entry with each 3D rendering platform 10 to maintain consistency across the 3D rendering platforms 10, and thus ensures that any changes or updates made to the avatar or assets in one of the 3D rendering platforms 10 are reflected across all other platforms, providing a seamless user experience. Finally, the multi-application caching module 460 also efficiently manages the cache storage by regularly checking for outdated or unused avatar models and assets and removing them as necessary. By eliminating duplicate entries, the multi-application caching module 460 conserves storage space and enhances the overall performance of the user device 300.

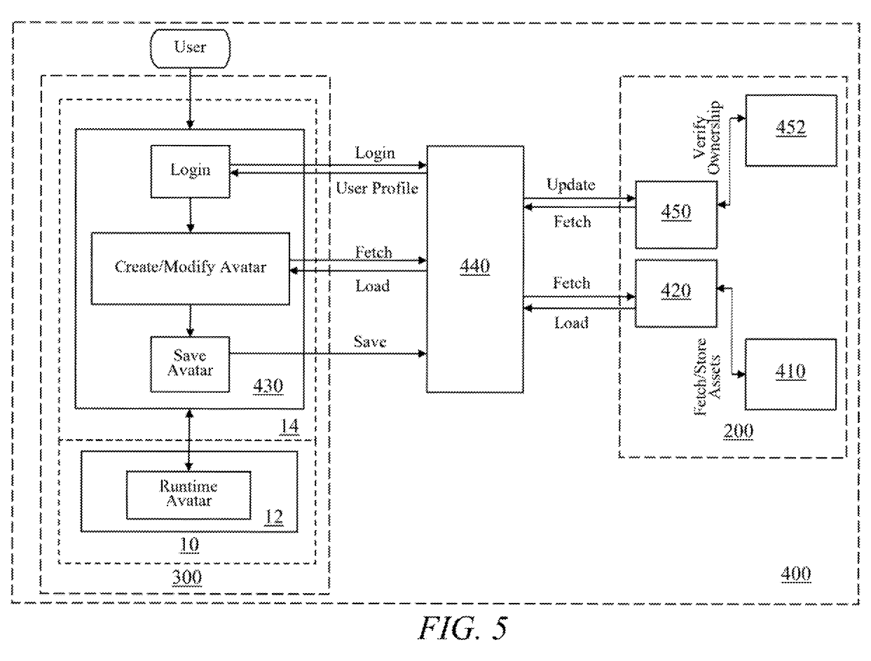

Referring to FIG. 5, illustrated is a schematic diagram depicting process flow for implementation of the present system 400 for managing the avatar for the user for use in the multiple 3D rendering platforms 10. The user initiates the process by logging in to the SDK module 430, which is integrated into the in-engine avatar customization module 14 of each 3D rendering platform 10. The login request is sent to the user account module 450 via the API module 440. The user account module 450 verifies the user's credentials and grants them access to their avatar and associated assets, via the API module 440. The user account module 450 incorporates the distributed ledger 452 to record and manage the ownership of the avatar and associated assets. Upon successful login, the user is presented with options to create a new avatar or modify an existing one using the in-engine avatar customization module 14. The user may customize their avatar by choosing from the available assets, such as clothing items, facial features, hair textures, and accessories. Once the user is satisfied with their avatar's appearance, they can save the changes by selecting a save option within the SDK module 430. The SDK module 430 then sends a request to the API module 440, which in turn communicates with the content delivery module 420 to fetch the updated 3D model of the avatar and the selected assets. The content delivery module retrieves the updated 3D avatar model and assets from the content database 410 and delivers them to the SDK module 430. The content database 410 then stores the 3D avatar model and its associated assets for future use. As the user interacts with different 3D rendering platforms 10, they can continue to customize their avatar using the in-engine avatar customization module 14 and the available assets. Any changes made during these sessions are saved and synchronized across platforms through the SDK module 430.

In an embodiment, as illustrated in FIG. 5, the content database 410 and the content delivery module 420 are executed on a server (such as, the server 200). This setup allows for centralized storage and management of the 3D models of avatars, along with their associated first and second assets. The server 200 provides the necessary computational resources and network connectivity to manage the content database 410 effectively and to deliver assets to the SDK module 430 via the content delivery module 420. By executing the content database 410 and the content delivery module 420 on the server 200, the system 400 may efficiently handle multiple requests from different user devices 300 simultaneously, maintaining its performance and responsiveness. The server-based architecture also facilitates easy updates and maintenance for the system 400, as any changes or improvements to the content database 410 or the content delivery module 420 may be implemented on the server-side without requiring updates on the individual user devices 300.

In a specific embodiment, the server 200 is a cloud-based server. Such cloud-based server offers scalability, flexibility, and reliability to efficiently manage the storage and delivery of avatars and associated assets. By utilizing the cloud-based server 200, the content database 410 may store a vast amount of data, including 3D models of avatars, first assets, and second assets, and easily scale its storage capacity as the user base grows. This allows the system 400 to accommodate increasing amounts of data without compromising performance or availability. Further by operating in the cloud-based server 200, the content delivery module 420 may efficiently serve requests from multiple users simultaneously while maintaining low latency and high throughput. In some examples, the content delivery module 420 may be configured to implement an edge server based on a location and/or a bandwidth of the user device 300 for faster delivery to and fetching from the SDK module 430. This cloud-based architecture ensures that the system 400 may effectively manage and deliver avatar data to users across multiple 3D rendering platforms while maintaining optimal performance, security, and scalability.

In an alternate embodiment, the content database 410 and the content delivery module 420 are executed in the user device 300 (not illustrated). With this configuration, the user device takes on the responsibility of locally managing the content database 410 and delivering assets via the content delivery module 420. It may be understood that when the content database 410 and the content delivery module 420 are executed in the user device 300, the system 400 allows for a more decentralized approach to storing and managing the 3D models of avatars, along with their associated assets. By executing the content database 410 and the content delivery module 420 on the user device 300, the system 400 may be able to reduce latency and dependence on server resources, as the data is fetched locally instead of requiring communication with a remote server. Thereby, this approach can improve the responsiveness and performance of the system 400 on the user's end.

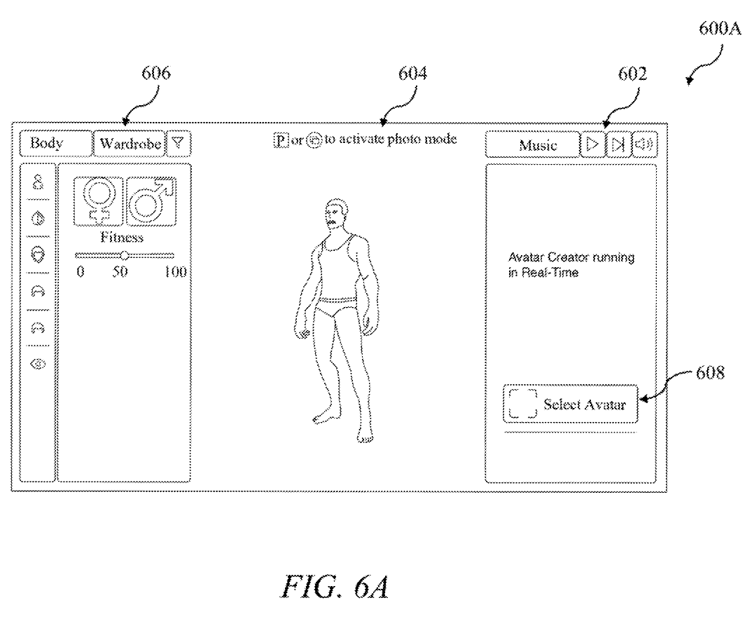

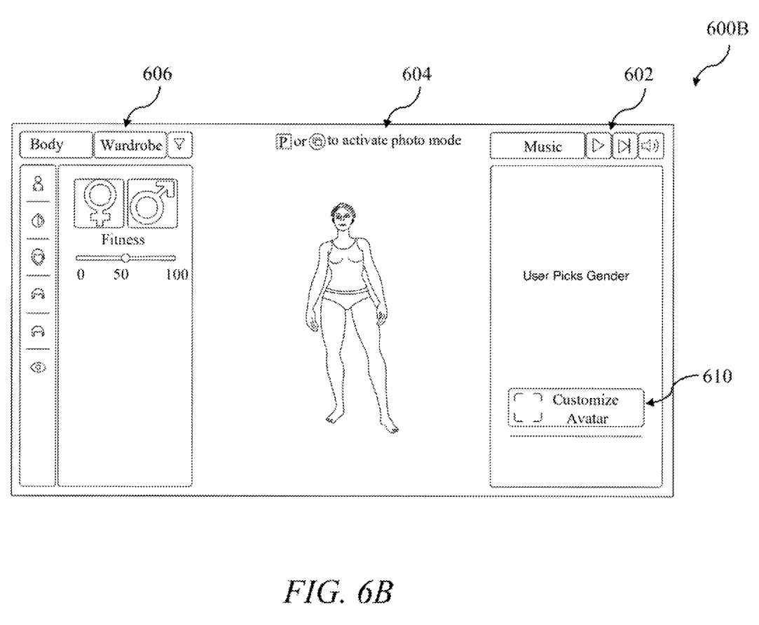

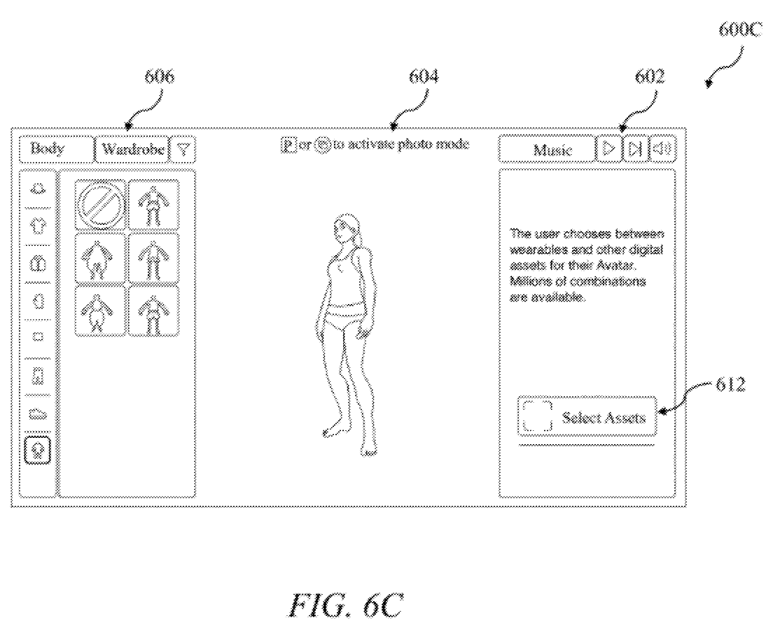

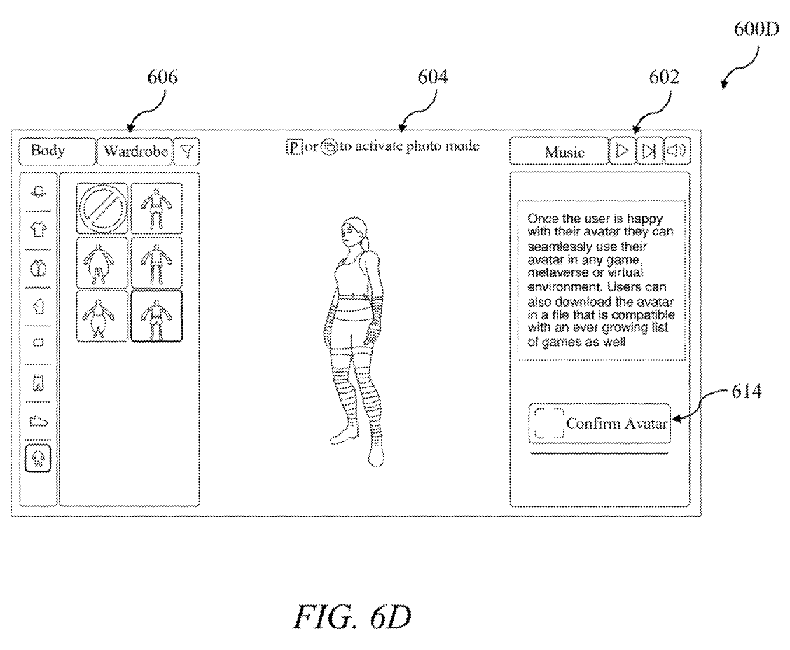

Referring to FIGS. 6A- 6D, illustrated are example depictions of various interfaces which may be implemented to allow the user to manage the avatar as per embodiments of the present disclosure. In particular, FIG. 6A depicts a first interface 600A which provides a dynamic and interactive environment for users to design and customize their avatars in real-time. As users make changes to their avatars, the first interface 600A immediately reflects the alterations, allowing them to visualize their creations without delay. This instant feedback enhances the user experience and promotes a more intuitive and enjoyable avatar design process. In particular, the first interface 600A provides a music panel 602 which allows the users to add music assets to their avatar. The first interface 600A also provides a photo panel 604 which allows the users to add a photo or click a photo (from an associated camera device, like webcam) to customize the avatar accordingly. The first interface 600A further provides a profile panel 606 which allows the users to change profile of the avatar, like selecting gender, changing body type, changing fitness level, adding wardrobe elements, etc. The first interface 600A further provides a Select Avatar button 608 for the user to select the displayed avatar. It may be appreciated that the illustrated first interface 600A is an example only and shall not be construed as limiting to the present disclosure in any manner.

FIG. 6B depicts a second interface 600B which enables users to choose the gender of their avatar at the initial stage of the creation process. This choice sets the foundation for the avatar's appearance and informs the subsequent customization options available. By offering a user-friendly interface for gender selection, the system 400 ensures that users may easily create avatars that align with their preferences and identity. The second interface 600B provides a Customize Avatar button 610 for the user to customize the displayed avatar. As soon as the gender selection or any other action related to change in the body profile of the avatar may be completed by the user, the corresponding avatar image may change in the second interface 600B to reflect such action of the user.

FIG. 6C depicts a third interface 600C which allows users to personalize their avatars by selecting from a wide variety of assets including clothing, accessories, hairstyles, and other customizable elements. With numerous possible combinations, users can create a unique avatar that reflects their style and personality. The third interface 600C provides a Select Assets button 612 for the user to select the assets for the avatar. The third interface 600C fosters creativity and self-expression, enhancing the overall avatar creation experience.

FIG. 6D depicts a fourth interface 600D which enables the user to seamlessly use their avatar in the multiple 3D rendering platforms 10. The fourth interface 600D provides a Confirm Avatar button 614 for the user to finalize the displayed avatar. That is, upon finalizing their avatar design, the user can take advantage of the SDK module 430 to effortlessly integrate their avatar into various 3D rendering platforms 10, including games, metaverses, and virtual environments. Additionally, the fourth interface 600D may offer the users the option to download their avatar as an FBX (Filmbox), GLB (GL Binary), GLTF (Graphics Library Transmission Forma), or VRM (Virtual Reality Modeling) file, ensuring compatibility with a wide range of gaming platforms and applications. Thus, the fourth interface 600D empowers users to fully enjoy and utilize their custom avatars across multiple digital environments.

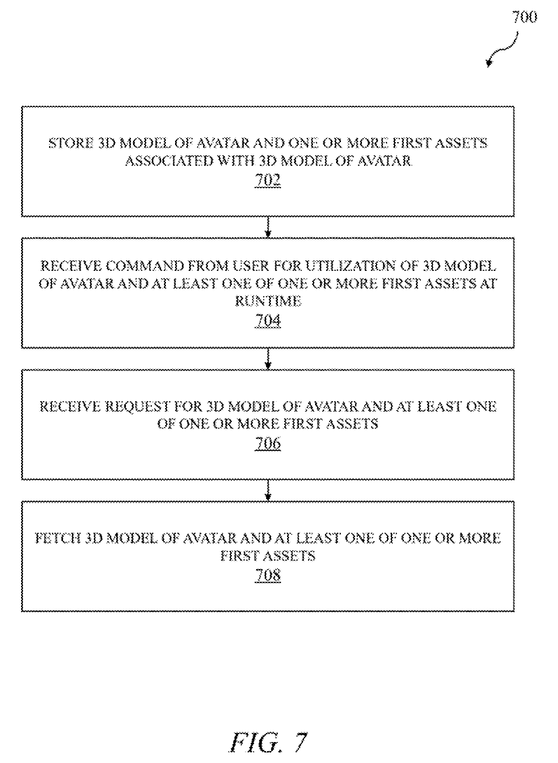

The present disclosure further provides a method for managing an avatar for a user for use in the multiple 3D rendering platforms 10. Referring now to FIG. 7, illustrated is a flowchart for the said method (as represented by reference numeral 700) listing steps involved therein. Various embodiments and variants disclosed above with respect to the system 400 for managing the avatar apply mutatis mutandis to the present method 700. Thus, the details as described above with respect to specific elements have not been repeated herein for brevity of the present disclosure. Also, it may be contemplated that steps (as described hereinafter) for the method 700 are only illustrative and other alternatives can also be provided where one or more steps are added, one or more steps are removed, or one or more steps are provided in a different sequence without departing from the spirit and the scope of the present disclosure.

At step 702, the method 700 includes storing, in the content database, the 3D model of the avatar and the one or more first assets associated with the 3D model of the avatar, as available with the user. This step 702 involves creating a storage system for the user's avatar and its associated assets, ensuring they are readily accessible for future use. At step 704, the method 700 includes receiving a command from the user for utilization, via the SDK module 430 integrated with the in-engine avatar customization module 14 of each one of the multiple 3D rendering platforms 10, of the said 3D model of the avatar and at least one of the said one or more first assets compatible with the corresponding in-engine avatar customization module 14 at the runtime, to customize the avatar. This step 704 involves the user interacting with the SDK module 430 to request the customization of their avatar using the available assets in real-time, which is made possible by integrating the SDK module 430 with the in-engine avatar customization module 14. At step 706, the method 700 includes receiving the first request from the SDK module 430 for the said 3D model of the avatar and the said at least one of the one or more first assets. That is, the first request is received from the SDK module 430 to access the user's avatar and its associated assets. At step 708, the method 700 includes fetching the said 3D model of the avatar and the said at least one of the one or more first assets from the content database 410 in response to the said first request, for delivery to the SDK module 430. Herein, the API module 440 retrieves the requested avatar and assets from the content database 410 and delivers them to the SDK module 430 for use in customizing the avatar.

In one or more embodiments, the method 700 also includes fetching the one or more second assets utilized by the user for customization of the avatar as available in and by implementation of the said corresponding in-engine avatar customization module 14. This step involves accessing additional assets that the user has acquired or created within the 3D rendering platforms. The method 700 further includes receiving the second request from the SDK module 430 for the said one or more second assets for storage in the content database 410. Herein, the API module 440 receives the second request to store the new assets in the content database 410 for future use. The method 700 further includes fetching the said one or more second assets from the SDK module 430 in response to the said second request. Herein, the API module 440 retrieves the new assets from the SDK module 430. The method 700 further includes storing the said one or more second assets in the content database 410. That is, the new assets are stored in the content database 410 alongside the user's avatar and first assets.

In one or more embodiments, the method 700 further includes recording ownership of the 3D model of the avatar, the one or more first assets, and the one or more second assets for the user. This step utilizes the user account module 450 to ensure that users maintain ownership of their avatars and associated assets. For this purpose, the method 700 further includes implementing the distributed ledger 452 for recording the ownership of the 3D model of the avatar, the one or more first assets, and the one or more second assets for the user. The distributed ledger 452, such as a blockchain, is used to record ownership information securely and transparently.

The present disclosure offers several advantages over existing solutions. Firstly, the system 400 and the method 700 provide a seamless experience for the user, allowing them to easily interchange their avatars and assets between games and metaverses without the need for manual import and export processes. This saves time and effort for the user, enhancing their overall experience. Secondly, the system 400 and the method 700 offer a more efficient way to manage avatar ownership and associated assets using the distributed ledger 452, which ensures a transparent and decentralized method for managing asset ownership. This can help to prevent disputes and provide users with greater control over their avatars and assets. Lastly, the multi-application caching module 460 helps to optimize resource usage by deleting duplicate entries of avatar and asset data between multiple real-time 3D rendering platforms in the user device 300. This can improve the performance of the system 400 and reduce the amount of storage space used on the user device 300. Overall, the present disclosure provides a more seamless and efficient way to manage avatars and their associated assets for use across multiple real-time 3D rendering platforms 10, addressing the limitations of existing solutions and improving the user experience.

### Digital Asset Governance for Portable Avatars

The following sections describe a governance framework that extends the capabilities of the avatar management system described above. This framework provides a robust mechanism for ensuring the authenticity, provenance, and policy compliance of the portable digital avatars and their associated assets, particularly when they are recreated via reconstruction.

A. Definitions (non-limiting)

Synthetic Transport means a computer-implemented transport protocol wherein a deployable digital asset representation is produced at a destination by semantic extraction and re-synthesis from indirect evidence rather than bitstream copying of a source file payload or transfer of a source token record.

Indirect Evidence means observational or descriptive data derived from rendering or observation of an asset, including pixels, frames, ray-traced samples, prompts, descriptors, measurements, style guides, reference packs, proxy geometry, partial extracts, or feature descriptors. In at least one embodiment, indirect evidence excludes the archival source asset file format.

Similarity Contract means a signed, machine-readable data structure issued by an authority defining canonicalization procedures, similarity metrics, classification zones, and machine-enforceable policy requirements for outputs within regulated zones.

Evidence Commitment means a cryptographic commitment representing indirect evidence, including a byte commitment, a feature commitment, a segment commitment, or a dual commitment. A feature commitment may be derived from canonical evidence representations such that superficial byte changes do not avoid classification.

Pipeline Identity Commitment means a cryptographic commitment representing identity of a reconstruction pipeline, including one or more of: tool identifiers, versions, model identifiers, model version identifiers, weight hashes, adapter identifiers, configuration commitments, or certified component attestations.

Output Commitment means a cryptographic commitment representing an output digital asset, including a byte commitment, a feature commitment, a segment commitment, or a dual commitment. Segment commitments may separately commit to components such as mesh, texture, material graph, rig, animation, decals, audio, VFX, physics parameters, or gameplay metadata.

Derived-Asset Receipt means a verifiable computer data structure binding at least the evidence commitment, pipeline identity commitment, output commitment, a contract identifier, a derived classification, and a policy anchor. The receipt may additionally include freshness seals, revocation pointers, selective disclosure proofs, and/or audit commitments.

Policy Anchor means a pointer, hash, identifier, or capability token referencing a machine-enforceable policy object configured to control computer behavior at enforcement points, including restrictions on import, compilation, packaging, runtime activation/equip, capture/export, listing visibility, settlement routing, withholding/escrow routing, watermark/marking requirements, substitution variants, revocation behaviors, and monetization enablement.

Destination means any system that accepts, deploys, compiles, distributes, executes, lists, or monetizes the digital asset, including studios, publishers, marketplaces, build systems, repositories, engines, render farms, DCC pipeline managers, or enterprise content platforms.

Enforcement Point means a concrete control interface in a toolchain or runtime, including repository commit gates, CI/CD build gates, export gates, packaging and signing gates, engine import gates, runtime activation/equip gates, capture/export gates, marketplace listing gates, settlement gates, or payment release gates.

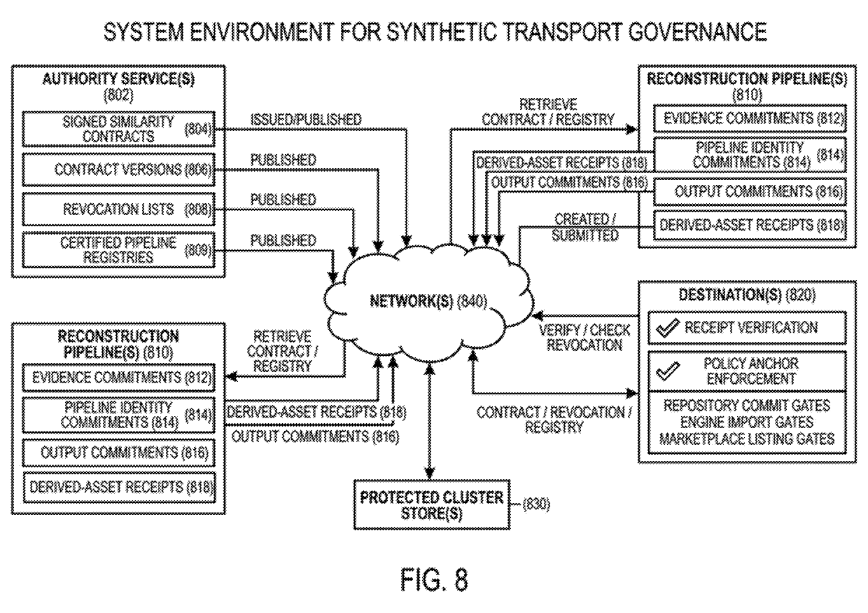

B. System Overview (FIG. 8)

FIG. 8 depicts an example system environment comprising Authority Service(s) (802), one or more Reconstruction Pipelines (810), one or more Destinations (820), and one or more Protected Cluster Stores (830). Communications occur over one or more networks (840).

In one embodiment, Authority Service(s) (802) can issue signed similarity contracts (804), publish contract versions (806), and optionally publish revocation lists (808) and certified pipeline registries (809).

Reconstruction pipeline(s) (810) may include DCC software, conversion pipelines, generative model services, scripted tools, render farm services, or build-time transformation services. Reconstruction pipeline(s) (810) can generate evidence commitments (812), pipeline identity commitments (814), output commitments (816), and derived-asset receipts (818).

Destinations (820) include enforcement points such as repository commit gates, CI/CD build gates, packaging/signing tools, engine import gates, runtime activation gates, marketplace listing gates, and settlement/payment gates. Destinations verify receipts and enforce policy anchors.

Protected Cluster Store(s) (830) maintain cluster identifiers, feature descriptors, and associated policy anchors for use in similarity matching and policy attachment operations. In one embodiment, the Protected Cluster Store(s) (830) enable policy attachment without requiring knowledge of a source asset's unique identifier, instead relying on feature-based matching to determine applicable governance requirements.

In operation, the Authority Service (802) publishes similarity contracts (804) and contract versions (806) to the networks (840), making them available to both Reconstruction Pipelines (810) and Destinations (820). The Reconstruction Pipeline (810) retrieves applicable contract and registry information from the networks (840), generates the necessary commitments (812, 814, 816), and produces derived-asset receipts (818) that are submitted along with output commitments (816) to the networks (840). Destinations (820) retrieve contract, revocation, and registry information from the networks (840) and receive the derived-asset receipts (818), pipeline identity commitments (814), and output commitments (816) for verification. The Destinations (820) perform receipt verification and policy anchor enforcement at their respective enforcement points, checking revocation status against the revocation lists (808) published by the Authority Service (802). The certified pipeline registries (809) enable Destinations (820) to verify that a Reconstruction Pipeline (810) is authorized to issue receipts for particular asset categories or classification zones.

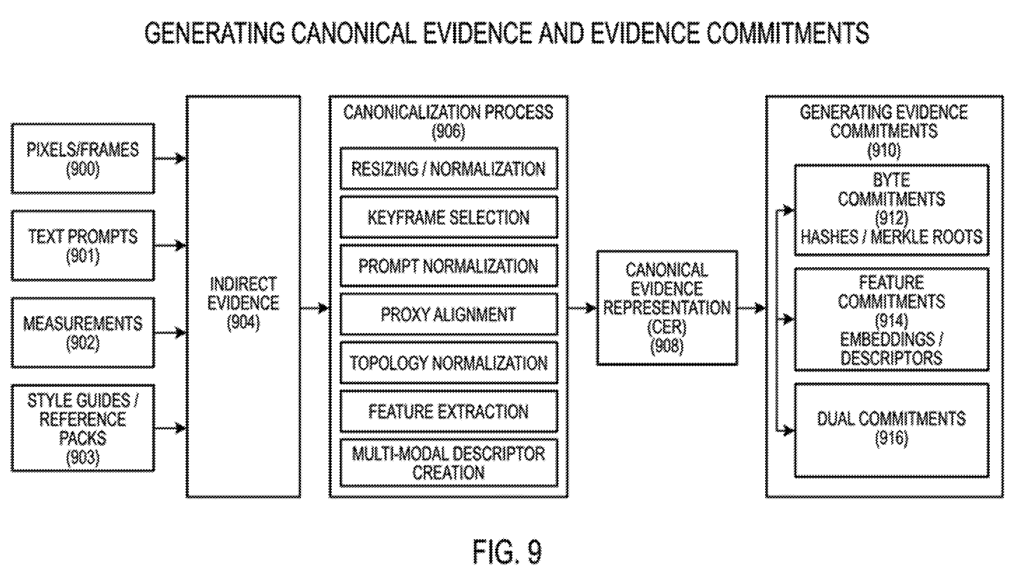

C. Indirect Evidence Canonicalization and Evidence Commitments (FIG. 9)

FIG. 9 illustrates capturing indirect evidence (904) and generating a canonical evidence representation (908). Canonicalization may include resizing, normalization, keyframe selection, prompt normalization, proxy alignment, topology normalization, extraction of robust features, or creation of multi-modal descriptors.

Evidence commitments (910) may include byte commitments 912 (hashes or Merkle roots of evidence packages), feature commitments 914 (commitments to embeddings/descriptors), and dual commitments 916 combining both. In one embodiment, a similarity contract specifies commitment types by asset category.

Asset categories van include, without limitation: characters, character skins, cosmetics, weapons, vehicles, props, tools, pets, decals, emotes, VFX, environments, buildings, terrain, shaders, materials, and UI skins.

In the embodiment of FIG. 9, the process begins with the collection of various forms of indirect evidence (904). Pixels/frames (900) represent rendered imagery or video captures of an asset. Text prompts (901) comprise descriptive or generative prompts used to guide reconstruction. Measurements (902) include dimensional, geometric, or other quantitative data derived from observation of an asset. Style guides/reference packs (903) encompass curated collections of visual or stylistic references that inform the reconstruction process.

These diverse input types are processed through a canonicalization process (906), which transforms the raw indirect evidence (904) into a standardized format suitable for commitment generation and similarity evaluation. The canonicalization process (906) applies operations such as resizing, normalization, keyframe selection, prompt normalization, proxy alignment, topology normalization, feature extraction, and multi-modal descriptor creation. The output of the canonicalization process (906) is a canonical evidence representation (908), which provides a normalized and reproducible representation of the input evidence regardless of superficial variations in the original capture or description.

The canonical evidence representation (908) serves as the input for generating evidence commitments (910). The generating evidence commitments (910) stage produces cryptographic commitments that bind the evidence to subsequent verification operations. Byte commitments (912) are computed as hashes or Merkle roots of the evidence packages, providing integrity verification at the byte level. Feature commitments (914) are derived from embeddings and descriptors that capture semantic characteristics of the evidence, ensuring that superficial byte-level changes do not circumvent classification. Dual commitments (916) combine both byte commitments and feature commitments, providing comprehensive cryptographic binding that addresses both integrity and semantic similarity concerns. The selection of commitment types may be governed by the applicable similarity contract based on the asset category being processed.

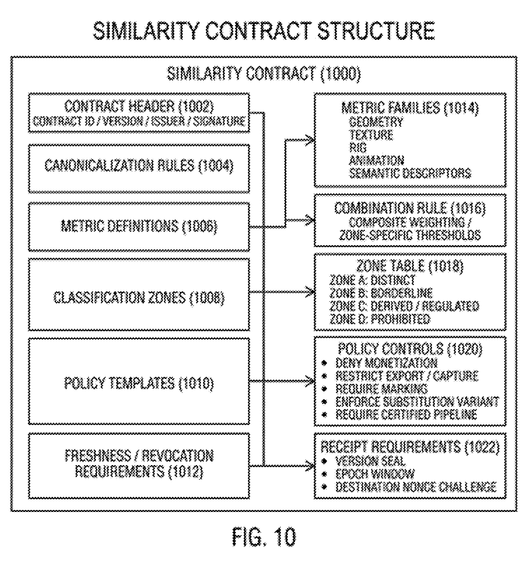

D. Similarity Contracts (FIG. 10)

FIG. 10 depicts a similarity contract (1000) including: a contract header (1002), canonicalization rules (1004), metric definitions (1006), classification zones (1008), policy templates (1010), and freshness/revocation requirements (1012).

Metric definitions (1006) may include multi-modal metrics, illustrated as metric families (1014). The metric families (1014) include geometry, texture, rig, animation, and semantic descriptors. A combination rule (1016) can provide a composite weighting and zone-specific thresholds for combining multiple metric families (e.g., weighted sum, min-of-max, or zone-specific arbitration).

Classification zones (1008) define at least one regulated zone. A non-limiting example includes: • Zone A (Distinct): below a first threshold; • Zone B (Borderline): between thresholds; may trigger quarantine/review/marking or restricted capabilities; • Zone C (Derived/Regulated): above a threshold; triggers required policy attachment; • Zone D (Prohibited): triggers denial, substitution variants, or restricted rendering-only modes.

The zone table (1018) enumerates these classification zones with their corresponding threshold ranges and associated policy requirements, providing a structured lookup for determining how a given similarity score maps to governance obligations. In one embodiment, Zone A (Distinct) encompasses assets whose similarity scores fall below a first threshold, indicating sufficient differentiation from protected assets such that no governance obligations attach. Zone B (Borderline) encompasses assets whose similarity scores fall between the first threshold and a second threshold, indicating potential similarity that may trigger quarantine, manual review, marking requirements, or restricted capabilities pending further evaluation. Zone C (Derived/Regulated) encompasses assets whose similarity scores exceed the second threshold, indicating sufficient similarity to protected assets that required policy attachment is triggered, including settlement routing, withholding, or other machine-enforceable obligations. Zone D (Prohibited) encompasses assets whose similarity scores exceed a third threshold or match specific prohibited patterns, triggering denial of acceptance, mandatory substitution with authorized variants, or restriction to rendering-only modes that prevent distribution or monetization.

Policy templates (1010) reference machine-enforceable policy objects controlling destination behavior through policy controls (1020), including: deny monetization, restrict runtime capabilities, restrict export/capture, require marking, require settlement routing/withholding, enforce substitution variants, or require certified pipeline issuance.

Policy controls (1020) enumerate specific enforcement actions that may be triggered based on classification zone assignment. These policy controls include deny monetization, which prevents revenue generation from the asset; restrict export or capture, which limits the ability to extract or record the asset; require marking, which mandates visible or embedded identification; enforce substitution variant, which requires replacement with an authorized alternative; and require certified pipeline, which restricts issuance of valid receipts to pipelines registered in the certified pipeline registries (809).

Freshness requirements (1012) may include receipt requirements (1022) that can specify that receipts include (i) a contract version seal and/or (ii) a time/epoch window and/or (iii) a destination challenge nonce. In one embodiment, regulated categories can include challenge-response receipts to prevent replay.

Receipt requirements (1022) specify the components that may be present in a derived-asset receipt to satisfy the freshness/revocation requirements (1012). These receipt requirements include a version seal that binds the receipt to a specific version of the similarity contract, ensuring that receipts generated under outdated contract versions can be identified and rejected. An epoch window defines a temporal validity period during which the receipt remains valid, preventing the use of stale receipts that may no longer reflect current policy requirements or revocation status. A destination nonce challenge enables challenge-response verification, wherein the destination provides a unique nonce that may be incorporated into the receipt, preventing replay attacks where a valid receipt is reused across multiple verification sessions or destinations. In one embodiment, the freshness/revocation requirements (1012) mandate that receipts for assets in regulated categories satisfy all three components to be considered valid at an enforcement point.

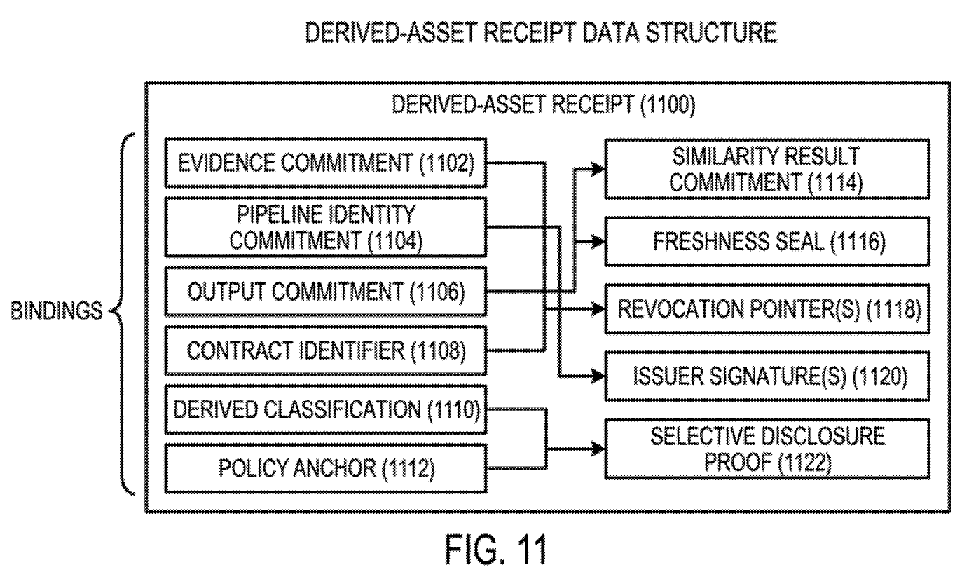

E. Derived-Asset Receipt Data Structure (FIG. 11)

FIG. 11 depicts a derived-asset receipt (1100) as a specialized computer data structure comprising bindings among: evidence commitment (1102), pipeline identity commitment (1104), output commitment (1106), contract identifier (1108), derived classification (1110), and policy anchor (1112).

Receipt (1100) may further include: a similarity result commitment (1114) for auditability; a freshness seal (1116) including one or more of: epoch window, contract version seal, or destination nonce challenge; revocation pointer(s) (1118) referencing revocation registries; issuer signature(s) (1120) including pipeline signatures and optional authority endorsements; and selective disclosure proof (1122) enabling verification without raw evidence disclosure.

The receipt bindings prevent workarounds such as using a receipt produced for one output with a different output, changing the governing contract, or presenting a receipt produced by an unauthorized pipeline for a regulated category.

In the embodiment of FIG. 11, the derived-asset receipt (1100) establishes a cryptographically verifiable chain of custody that links the reconstruction process to its governance obligations. The evidence commitment (1102) binds the receipt to the specific indirect evidence from which the output asset was reconstructed, preventing substitution of different source material after receipt issuance. The pipeline identity commitment (1104) identifies the reconstruction pipeline that produced the output, enabling verification that the pipeline was authorized to issue receipts for the applicable asset category. The output commitment (1106) binds the receipt to the specific output digital asset, preventing reuse of a receipt with a different reconstructed asset.

The contract identifier (1108) references the specific similarity contract under which the classification was performed, ensuring that the receipt cannot be presented as compliant with a different contract having different classification thresholds or policy requirements. The derived classification (1110) records the classification zone determined during similarity evaluation, providing a verifiable record of how the asset was categorized. The policy anchor (1112) references the machine-enforceable policy object that governs the asset at enforcement points, establishing the specific obligations that attach to the asset based on its classification.

The similarity result commitment (1114) provides an auditable record of the similarity evaluation without necessarily disclosing the raw similarity scores, enabling post-hoc verification and dispute resolution. The freshness seal (1116) incorporates temporal and contextual binding elements that prevent replay attacks and ensure the receipt reflects current contract versions and policy requirements. The revocation pointer(s) (1118) enable destinations to check whether the receipt or its underlying policy anchor has been revoked, supporting dynamic governance updates.

The issuer signature(s) (1120) provide cryptographic authentication of the receipt, enabling destinations to verify that the receipt was issued by an authorized pipeline. In some embodiments, authority endorsements may supplement pipeline signatures to provide additional assurance for regulated categories. The selective disclosure proof (1122) enables verification of classification and policy attachment without requiring disclosure of the raw evidence, supporting enterprise confidentiality requirements while maintaining governance integrity.

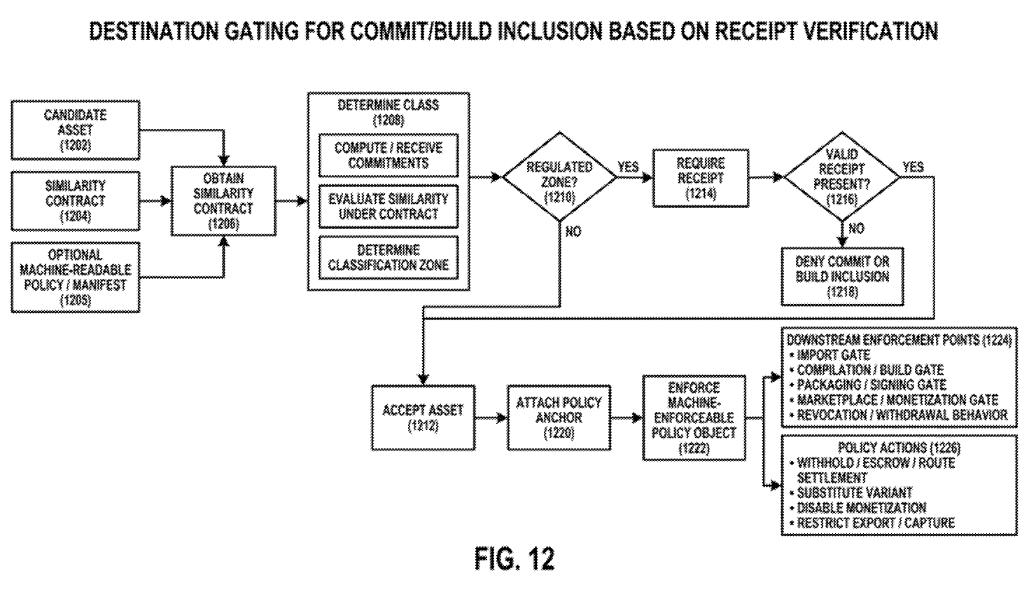

F. Receipt-Gated Enforcement at Enterprise Gates (FIGS. 12-14)

F1. Repository Commit and CI/CD Build Gates (FIG. 12)

FIG. 12 depicts enforcement logic wherein a destination pipeline receives a candidate asset (1202) and obtains an applicable similarity contract (1204). The destination computes or receives commitments, evaluates similarity under the contract, and determines a classification zone. If the asset is within a regulated zone, the destination may require a valid receipt. If missing, stale, or invalid, the destination denies commit or build inclusion. If valid, the destination accepts and attaches the policy anchor and enforces the machine-enforceable policy object at subsequent enforcement points.

In the embodiment of FIG. 12, the destination acceptance gate flow implements a structured decision process for repository commit and CI/CD build enforcement. The process begins when a candidate asset (1202) is received at the destination pipeline along with a similarity contract (1204) and an optional machine-readable policy/manifest (1205). The destination proceeds to obtain similarity contract (1206), retrieving the applicable contract that governs the asset category.

The process then advances to determine class (1208), where the destination computes or receives commitments, evaluates similarity under the contract, and determines a classification zone for the candidate asset. This evaluation produces a classification result that is assessed at the regulated zone? decision point (1210).

If the candidate asset is not within a regulated zone, the process proceeds directly to accept asset (1212), allowing the asset to be included in the repository or build without additional governance requirements. However, if the candidate asset falls within a regulated zone, the process moves to require receipt (1214), where the destination demands a valid derived-asset receipt.

At the valid receipt present? decision point (1216), the destination evaluates whether a compliant receipt accompanies the candidate asset. If a valid receipt is not present, or if the receipt is stale or invalid, the process proceeds to deny commit or build inclusion (1218), preventing the asset from entering the destination pipeline. If a valid receipt is present, the process proceeds to accept asset (1212).

Upon acceptance, the process continues to attach policy anchor (1220), where the policy anchor from the verified receipt is associated with the asset. The process then advances to enforce machine-enforceable policy object (1222), which activates the governance controls specified by the policy anchor.

The enforcement extends to downstream enforcement points (1224), which include import gate, compilation/build gate, packaging/signing gate, marketplace/monetization gate, and revocation/withdrawal behavior. These downstream points ensure that policy obligations propagate throughout the asset lifecycle. The policy actions (1226) that may be enforced include withhold/escrow/route settlement, substitute variant, disable monetization, and restrict export/capture.

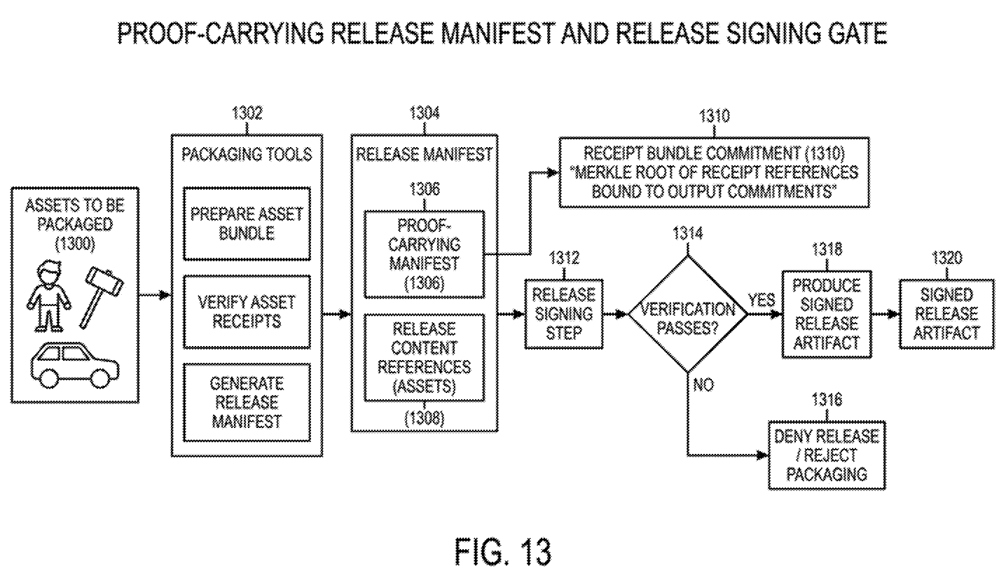

F2. Packaging and Release Signing Gates (FIG. 13)

FIG. 13 depicts packaging tools which may require that all included assets possess verified receipts where required. A release manifest includes a proof-carrying manifest comprising a receipt bundle commitment (e.g., Merkle root of receipt references bound to output commitments). In one embodiment, the release signing step produces a signed release artifact when proof-carrying manifest verification passes. This prevents omission of receipts during packaging and provides a durable compliance boundary at release time.

In the embodiment of FIG. 13, the packaging and release signing enforcement process ensures that governance obligations are preserved when assets are bundled for distribution. The process begins with assets to be packaged (1300), which represent the collection of digital assets intended for inclusion in a release. These assets are provided to packaging tools (1302), which perform several preparatory operations including preparing an asset bundle, verifying asset receipts, and generating a release manifest.

The packaging tools (1302) produce a release manifest (1304), which serves as a comprehensive record of the release contents. The release manifest (1304) comprises two key components: a proof-carrying manifest (1306) and release content references (1308). The proof-carrying manifest (1306) contains the governance-related attestations, while the release content references (1308) identify the specific assets included in the release.

Associated with the release manifest (1304) is a receipt bundle commitment (1310), which is computed as a Merkle root of receipt references bound to output commitments. This cryptographic structure enables efficient verification that receipts are present and correctly associated with their corresponding assets, without requiring individual verification of each receipt at signing time.

The process then proceeds to a release signing step (1312), which evaluates the proof-carrying manifest (1306) and the receipt bundle commitment (1310) to determine whether the release satisfies all governance requirements. Following the release signing step (1312), the process reaches a verification passes decision (1314).

If verification does not pass at the verification passes decision (1314), the process proceeds along the No branch to deny release / reject packaging (1316). This outcome prevents the creation of a signed release artifact when required receipts are missing, invalid, or improperly bound, thereby maintaining the integrity of the governance framework.

If verification passes at the verification passes decision (1314), the process proceeds along the Yes branch to produce signed release artifact (1318). This step generates a signed release artifact (1320), which represents the final, cryptographically authenticated release package that can be distributed to downstream systems.

This enforcement mechanism prevents the omission of receipts during packaging and establishes a durable compliance boundary at release time, ensuring that properly governed assets can be included in signed releases.

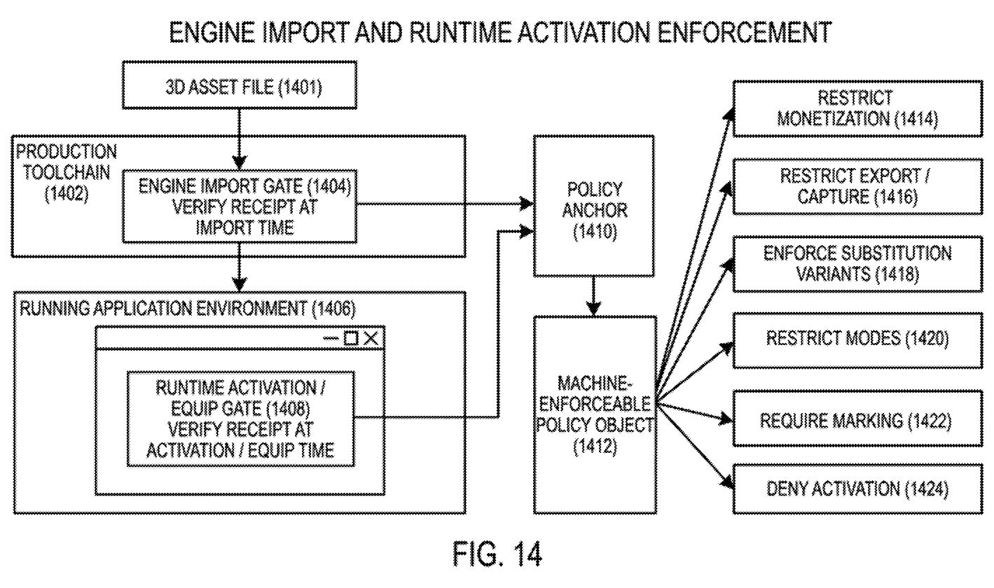

F3. Engine Import and Runtime Activation Gates (FIG. 14)

FIG. 14 depicts an engine import gate (1404) that can verify receipts at import time and a runtime activation/equip gate (1408) that can verify receipts at activation/equip time. A machine-enforceable policy object (1412) may restrict monetization (1414), restrict export/capture (1416), enforce substitution variants (1418), restrict modes (1420), require marking (1422), or deny activation (1424) when required by the policy anchor (1410). The gates are concrete computer interfaces that control execution and distribution outputs.

In the embodiment of FIG. 14, the engine import and runtime activation enforcement system provides granular control over asset deployment within a production environment. The process begins when a 3D asset file (1401) enters a production toolchain (1402). The production toolchain (1402) includes an engine import gate (1404), which is configured to verify receipts at import time. This engine import gate (1404) serves as a first enforcement checkpoint, preventing assets without valid derived-asset receipts from being imported into the 3D rendering platform.

The system further includes a running application environment (1406) that contains a runtime activation/equip gate (1408). The runtime activation/equip gate (1408) is configured to verify receipts at activation or equip time, providing a second enforcement checkpoint during application execution. This dual-gate architecture ensures that governance obligations are enforced both when assets enter the production pipeline and when they are activated for use within the running application.

Both the engine import gate (1404) and the runtime activation/equip gate (1408) connect to a policy anchor (1410). The policy anchor (1410) references a machine-enforceable policy object (1412) that controls various aspects of asset behavior and usage within the system. The machine-enforceable policy object (1412) connects to multiple policy enforcement actions that may be applied based on the classification and policy requirements associated with the asset.

The policy enforcement actions include restrict monetization (1414), which controls monetization capabilities for the asset and may prevent revenue generation from non-compliant assets. The restrict export/capture (1416) action limits the ability to export or capture the asset, preventing unauthorized extraction of protected content. The enforce substitution variants (1418) action manages variant substitution requirements, enabling the system to replace non-compliant assets with authorized alternatives. The restrict modes (1420) action controls available operational modes for the asset, potentially limiting functionality based on policy requirements. The require marking (1422) action enforces marking or watermarking requirements, ensuring that governed assets carry appropriate identification. The deny activation (1424) action prevents activation of non-compliant assets entirely, serving as the most restrictive enforcement option.

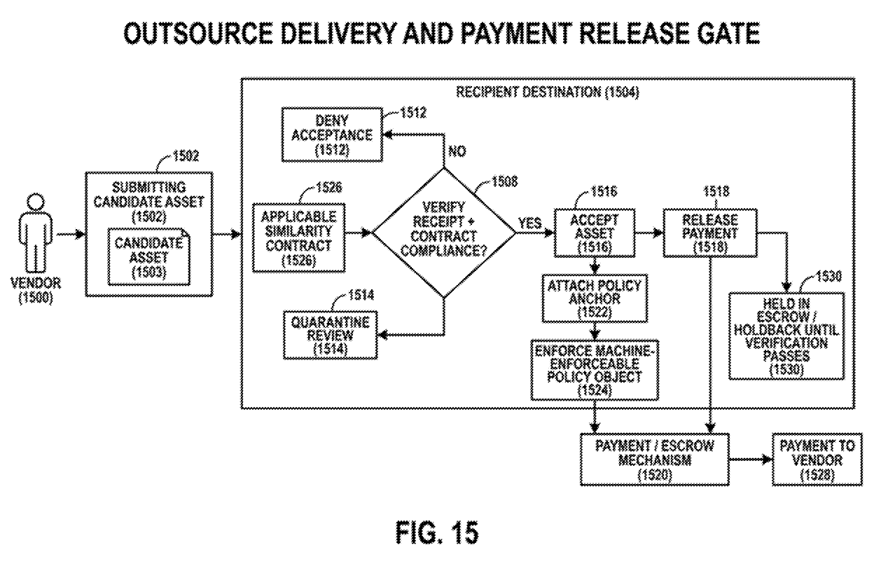

G. Outsource Delivery and Payment Release Gates (FIG. 15)

FIG. 15 depicts a vendor submitting a candidate asset (1502) to a recipient destination (1504). The recipient requires a derived-asset receipt compliant with a similarity contract. Verification occurs prior to acceptance and prior to payment release. In one embodiment, payment is held in escrow or holdback until verification passes and policy compliance is confirmed. In one embodiment, borderline classification triggers quarantine or manual review prior to release. In one embodiment, settlement routing/withholding is enforced per the policy anchor.

In the embodiment of FIG. 15, the outsource delivery and payment release gate process governs the acceptance of externally produced assets and the release of associated payments. The process begins when a vendor (1500) submits a candidate asset (1502) containing a candidate asset (1503) to a recipient destination (1504). The recipient destination (1504) references an applicable similarity contract (1526) to determine the governance requirements for the submitted asset.

The process proceeds to verify receipt and contract compliance (1508), where the recipient destination (1504) evaluates whether the candidate asset is accompanied by a valid derived-asset receipt that satisfies the requirements of the applicable similarity contract (1526). This verification step ensures that outsourced assets meet the same governance standards as internally produced assets.

If verification fails at the verify receipt and contract compliance (1508) step, the process proceeds along the No branch to deny acceptance (1512), preventing the non-compliant asset from entering the recipient's pipeline. This denial protects the recipient from accepting assets that lack proper provenance documentation or fail to meet policy requirements.

In cases where the classification is borderline or requires additional evaluation, the process may route to quarantine review (1514) before a final acceptance decision is made. This quarantine mechanism allows for manual review of assets that fall within ambiguous classification zones, enabling human oversight for edge cases without blocking the entire workflow.

If verification passes at the verify receipt and contract compliance (1508) step, the process proceeds along the Yes branch to accept asset (1516). Upon acceptance, the process branches into two parallel paths. One path leads to attach policy anchor (1522), which associates the policy anchor from the verified receipt with the accepted asset. This step then advances to enforce machine-enforceable policy object (1524), activating the governance controls specified by the policy anchor for subsequent handling of the asset.

The other path from accept asset (1516) leads to release payment (1518), which initiates the payment process for the vendor. The release payment (1518) step connects to held in escrow/holdback until verification passes (1530), indicating that payment may be conditionally held pending successful verification. Both the enforce machine-enforceable policy object (1524) and the held in escrow/holdback until verification passes (1530) feed into a payment/escrow mechanism (1520), which manages the financial aspects of the transaction according to the policy requirements.

The payment/escrow mechanism (1520) ultimately leads to payment to vendor (1528), completing the financial transaction once all verification and policy requirements have been satisfied. This architecture ensures that vendors receive payment after their submitted assets have been verified as compliant with the applicable similarity contract (1526) and any associated policy obligations have been properly attached and enforced.

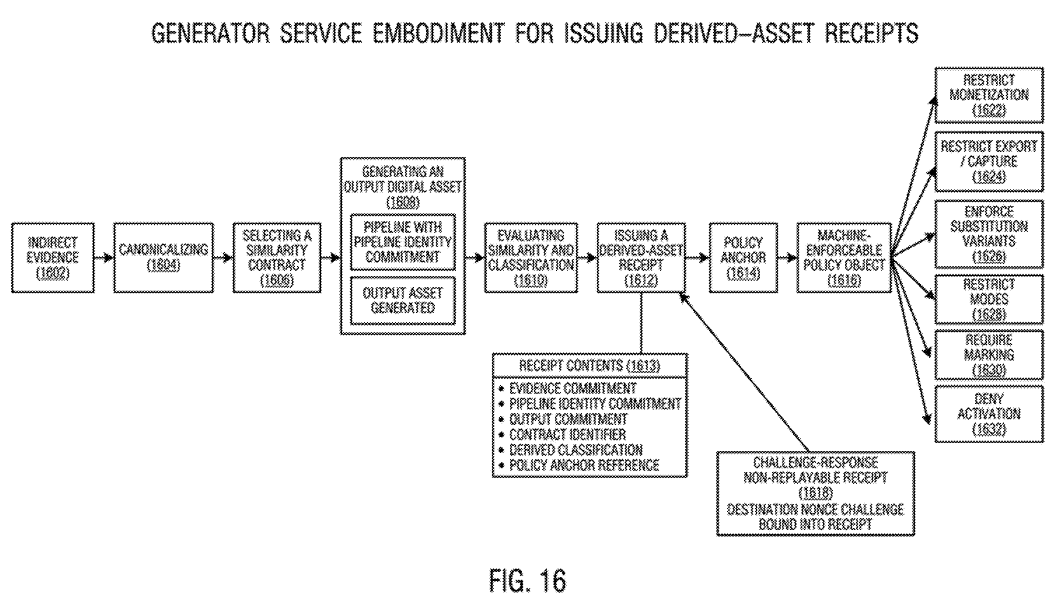

H. Generator Service Embodiments (FIG. 16)

FIG. 16 depicts a hosted generator service embodiment for issuing derived-asset receipts. The generator service can receive indirect evidence (1602), canonicalizing it (1604), selecting a similarity contract (1606), generating an output using digital asset (1608) using a pipeline with a pipeline identity commitment, evaluating similarity and classification (1610), issuing a derived-asset receipt (1612), and delivering output + receipt to downstream destinations via policy anchor (1614). In one embodiment, the generator service requests a destination nonce challenge and binds the nonce into the receipt freshness seal, producing a challenge-response receipt that is non-replayable.

In the embodiment of FIG. 16, the generator service embodiment illustrates a comprehensive workflow for issuing derived asset receipts bound to pipeline identity and delivering proof-carrying outputs. The process begins when indirect evidence (1602) is received by the hosted generation service. This indirect evidence (1602) may comprise rendered imagery, video captures, text prompts, or other observational data derived from a source digital asset.

The indirect evidence (1602) proceeds to canonicalizing (1604), where the evidence is transformed into a standardized format suitable for commitment generation and similarity evaluation. The canonicalization step ensures that the evidence representation is normalized and reproducible regardless of superficial variations in the original capture or description.

Following canonicalization, the process advances to selecting a similarity contract (1606). The similarity contract (1606) defines the applicable canonicalization procedures, similarity metrics, classification zones, and machine-enforceable policy requirements that govern the reconstruction process. The selection of an appropriate similarity contract (1606) ensures that the output asset will be evaluated against the correct governance criteria.

The process then proceeds to generating an output digital asset (1608), which involves executing a reconstruction pipeline characterized by a pipeline identity commitment. The pipeline identity commitment cryptographically identifies the specific tools, models, versions, and configurations used in the reconstruction process, enabling subsequent verification that the output was produced by an authorized pipeline.

Concurrently or subsequently, the process performs evaluating similarity and classification (1610), where the output asset is compared against the criteria specified in the similarity contract (1606) to determine a derived classification zone. This evaluation determines whether the output falls within a distinct, borderline, regulated, or prohibited zone.

Based on the evaluation results, the process advances to issuing a derived-asset receipt (1612). The receipt contents (1613) include an evidence commitment binding the receipt to the indirect evidence, a pipeline identity commitment identifying the reconstruction pipeline, an output commitment binding the receipt to the specific output digital asset, a contract identifier referencing the governing similarity contract, a derived classification recording the determined zone, and a policy anchor reference.

The derived-asset receipt references a policy anchor (1614), which in turn references a machine-enforceable policy object (1616). The machine-enforceable policy object (1616) controls various enforcement actions at destination systems based on the classification and policy requirements.

The enforcement actions controlled by the machine-enforceable policy object (1616) include restrict monetization (1622), which prevents revenue generation from non-compliant assets; restrict export/capture (1624), which limits the ability to extract or record the asset; enforce substitution variants (1626), which involves replacement with authorized alternatives; restrict modes (1628), which limits available operational modes; require marking (1630), which mandates visible or embedded identification; and deny activation (1632), which prevents activation of non-compliant assets entirely.

The figure also depicts a challenge-response non-replayable receipt (1618), which represents an embodiment where the generator service requests a destination nonce challenge and binds the nonce into the receipt freshness seal. This binding ensures that the receipt cannot be reused across different verification sessions or destinations, preventing replay attacks and enhancing the security of the governance framework.

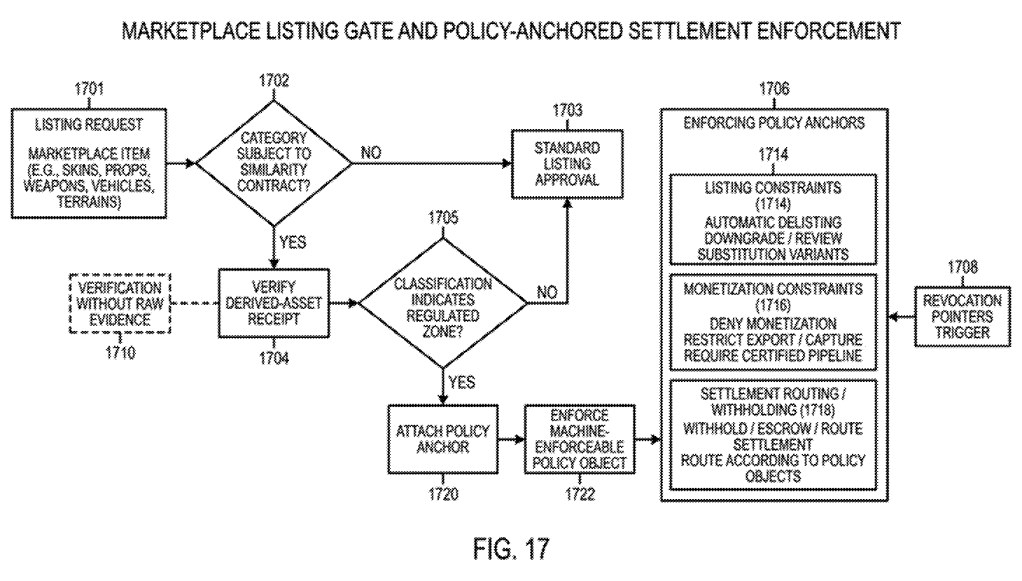

Marketplace Listing and Settlement (FIG. 17)

FIG. 17 depicts a marketplace listing system that includes receipt verification for categories subject to similarity contracts. When classification indicates a regulated zone, the marketplace enforces policy anchors including listing constraints, monetization constraints, and settlement routing/withholding. Revocation pointers may trigger automatic delisting, downgrade, or substitution variants. Settlement may route a share of revenue according to machine-enforceable policy objects without requiring disclosure of raw evidence.

In the embodiment of FIG. 17, the marketplace listing gate and policy-anchored settlement enforcement process governs the listing of reconstructed digital assets and the routing of associated payments. The process begins when a listing request (1701) is received for a marketplace item, which may be an item in an example category such as skins, props, weapons, vehicles, or terrains.

The process proceeds with a decision (1702) that determines whether the category of the requested listing is subject to a similarity contract. If the category is not subject to a similarity contract, the process proceeds along the No branch to standard listing approval (1703), allowing the listing to proceed without additional governance requirements.

If the category is subject to a similarity contract, the process proceeds along the Yes branch to verify derived-asset receipt (1704). This verification step may optionally involve verification without raw evidence (1710), enabling the marketplace to confirm compliance without requiring disclosure of the underlying source material. The verification ensures that the candidate asset is accompanied by a valid derived-asset receipt that satisfies the requirements of the applicable similarity contract.

Following verification, the process proceeds to a decision (1705) that determines whether the derived classification indicates a regulated zone. If the classification does not indicate a regulated zone, the process proceeds along the No branch to standard listing approval (1703). If the classification indicates a regulated zone, the process proceeds along the Yes branch to attach policy anchor (1720), which associates the policy anchor from the verified receipt with the listed asset.

The process then advances to enforce machine-enforceable policy object (1722), which activates the governance controls specified by the policy anchor. The enforcing policy anchors (1706) section encompasses several categories of constraints that may be applied based on the classification and policy requirements.

Listing constraints (1714) include automatic delisting, downgrade, review, and substitution variants, enabling the marketplace to control the visibility and availability of listed assets based on their governance status. Monetization constraints (1716) include deny monetization, restrict export or capture, and require certified pipeline, controlling the revenue-generating capabilities associated with the listed assets. Settlement routing / withholding (1718) includes withhold, escrow, route settlement, and route according to policy objects, enabling the marketplace to direct payment flows according to the policy requirements without requiring disclosure of raw evidence.

A revocation pointers trigger (1708) is connected to the enforcing policy anchors (1706) section, enabling automatic responses to revocation events. When revocation pointers indicate that a receipt or policy anchor has been revoked, the marketplace may automatically delist the asset, downgrade its listing status, or substitute it with an authorized variant, ensuring that governance obligations remain enforced throughout the asset's marketplace lifecycle.

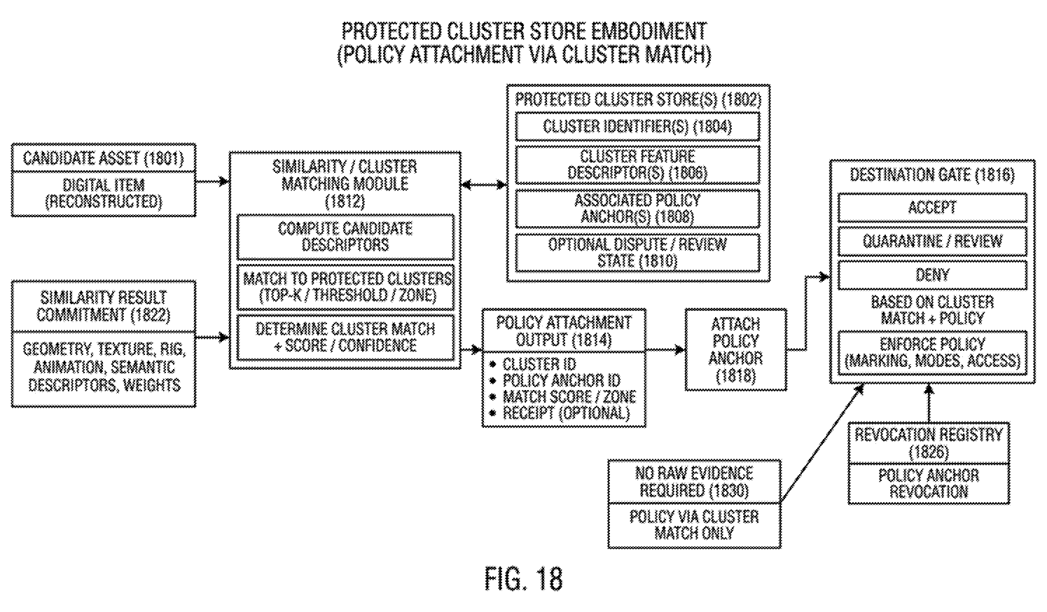

Protected Clusters and Policy Attachment Without Source UUID (FIG. 18)

FIG. 18 depicts a protected cluster store embodiment that can maintain cluster identifiers, feature descriptors, and associated policy anchors. A similarity contract may reference protected clusters as policy attachment sources. In one embodiment, the cluster store further maintains dispute workflow pointers and review states for borderline classifications, enabling enterprise handling without exposing raw evidence.

In the embodiment of FIG. 18, the protected cluster store embodiment implements policy attachment via cluster match, enabling governance of reconstructed digital assets without requiring knowledge of a source asset's unique identifier or exposure of raw evidence. The process depicts how a candidate asset (1801), which is a digital item that has been reconstructed, is matched against protected clusters to determine and attach appropriate policy controls.

The process begins with the candidate asset (1801) being provided to a similarity/cluster matching module (1812). Additionally, a similarity result commitment (1822) containing geometry, texture, rig, animation, semantic descriptors, and weights is also provided to the similarity/cluster matching module (1812). The similarity/cluster matching module (1812) performs two operations: computing candidate descriptors and matching to protected clusters using top-k, threshold, or zone-based approaches. The module then determines a cluster match score and confidence level.

The similarity/cluster matching module (1812) interfaces with protected cluster store(s) (1802), which contains several components. These components include cluster identifier(s) (1804), cluster feature descriptor(s) (1806), associated policy anchor(s) (1808), and an optional dispute/review state (1810). The protected cluster store(s) (1802) maintains the reference data against which candidate assets are compared, enabling policy attachment based on feature similarity rather than explicit source identification.

Following the matching operation, the similarity/cluster matching module (1812) produces a policy attachment output (1814). The policy attachment output (1814) includes a cluster ID, a policy anchor ID, a match score or zone designation, and optionally a receipt. The process indicates that no raw evidence is required (1830) and that policy is determined via cluster match.

The policy attachment output (1814) proceeds to an attach policy anchor (1818) step, which then feeds into a destination gate (1816). The destination gate (1816) provides three possible outcomes based on cluster match and policy: accept, quarantine/review, or deny. The destination gate (1816) also enforces policy including marking, modes, and access controls.

A revocation registry (1826) is connected to the destination gate (1816) and provides policy anchor revocation capabilities, enabling the system to invalidate previously issued policy anchors when necessary. This architecture enables verification of classification and policy attachment without exposing the underlying raw evidence, supporting enterprise confidentiality conditions while maintaining governance integrity throughout the asset lifecycle.

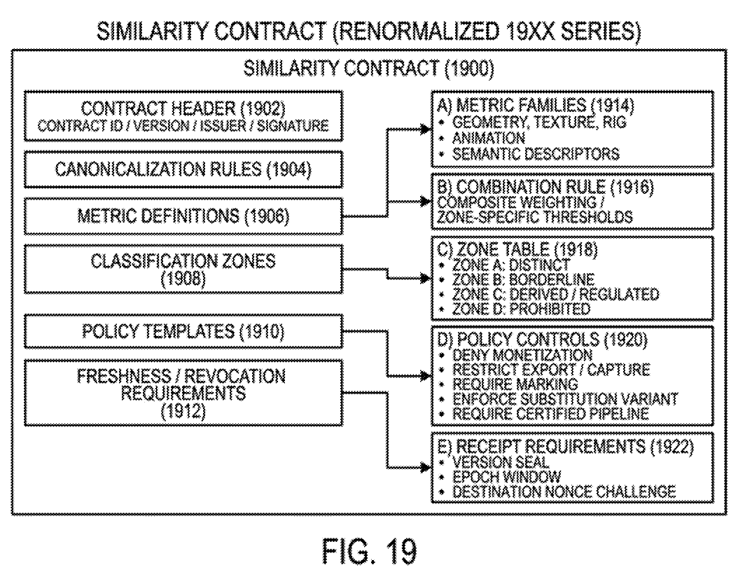

Selective Disclosure Verification (FIG. 19)

FIG. 19 depicts a receipt containing a selective disclosure proof, enabling a destination to verify derived classification and policy anchor validity without receiving raw evidence. This supports enterprise confidentiality and reduces incentives to remove governance tooling.

In the embodiment of FIG. 19, the similarity contract (1900) is configured to support selective disclosure verification, enabling destinations to validate classification and policy attachment without requiring access to raw evidence data. The similarity contract (1900) is organized as a data structure comprising several interconnected components that collectively define the parameters for asset classification, policy enforcement, and privacy-preserving verification.

The similarity contract (1900) includes a contract header (1902), which in this embodiment corresponds to the selective disclosure proof. The contract header (1902) contains identifying information such as contract ID, version, issuer, and signature, establishing the identity and authenticity of the similarity contract (1900). The contract header (1902) enables a verifier to confirm that a derived-asset receipt was issued under a valid contract and that the classification and policy anchor are correctly bound, without requiring the verifier to receive or process the underlying raw evidence.

Connected to the contract header (1902) are canonicalization rules (1904), which define the procedures for normalizing evidence data prior to commitment generation and similarity evaluation. The canonicalization rules (1904) ensure that evidence representations are standardized regardless of superficial variations in the original capture or description.

The similarity contract (1900) further includes metric definitions (1906), which specify the similarity measurements to be applied during classification. The metric definitions (1906) are associated with metric families (1914), which enumerate specific metric categories including geometry, texture, rig, animation, and semantic descriptors. A combination rule (1916) is linked to the metric definitions (1906) and specifies composite weighting and zone-specific thresholds for combining multiple metrics into a unified similarity assessment.

Classification zones (1908) define the boundaries for categorizing assets based on similarity scores. The classification zones (1908) are connected to a zone table (1918), which enumerates the specific zones including Zone A for distinct assets, Zone B for borderline cases, Zone C for derived or regulated assets, and Zone D for prohibited assets. Each zone carries different governance implications and policy requirements.

Policy templates (1910) reference machine-enforceable policy requirements and are associated with policy controls (1920). The policy controls (1920) specify enforcement actions such as deny monetization, restrict export or capture, require marking, enforce substitution variant, and require certified pipeline. These controls are activated at enforcement points based on the classification zone determined during similarity evaluation.

Freshness and revocation requirements (1912) define temporal validity constraints for receipts, ensuring that stale or revoked receipts cannot be used to bypass governance controls. The freshness and revocation requirements (1912) are connected to receipt requirements (1922), which specify version seal, epoch window, and destination nonce challenge parameters. The receipt requirements (1922) enable the generation of receipts that incorporate the selective disclosure proof of the contract header (1902), allowing verification of classification and policy attachment without exposing raw evidence data.

This architecture supports enterprise confidentiality by enabling destinations to verify that an asset has been properly classified and that appropriate policy anchors are attached, while the underlying evidence from which the asset was reconstructed remains protected. By reducing the need to share sensitive source material, the selective disclosure verification mechanism decreases incentives for parties to circumvent or remove governance tooling from their pipelines.

Integration of Governance Framework with Avatar Management System

The governance framework described herein directly complements the avatar management system. The "3D model of the avatar" and its associated "one or more first assets" (e.g., clothing, accessories) stored in the content database (410) are the "candidate target digital assets" governed by this framework. The "3D rendering platforms" (10), such as video games and metaverses, function as the "Destinations" (820). The in-engine avatar customization module (14) can be configured as an "Enforcement Point" that gates the import or activation of an asset based on the verification of its Derived-Asset Receipt. This ensures that even if a rare avatar skin is reconstructed from a screenshot, it cannot be used in a compliant game engine without a valid receipt, thus protecting the integrity of the user's digital identity and purchases.

In one embodiment, a computer-implemented method for governing portable digital assets is provided. The method comprises, at a destination content pipeline, receiving a candidate target digital asset for inclusion in a 3D rendering platform, wherein the candidate target digital asset is a component of a persistent digital avatar. The method further comprises obtaining a similarity contract that specifies at least a derived classification zone and a machine-enforceable policy requirement for assets classified therein. The method further comprises verifying a derived-asset receipt associated with the candidate target digital asset, the receipt providing a cryptographic binding between at least an evidence commitment, a pipeline identity commitment, and a policy anchor. The method further comprises gating acceptance of the candidate target digital asset into the 3D rendering platform based on the verifying.

In various embodiments, the candidate target digital asset may be one of: a 3D avatar model, a cosmetic skin, an article of clothing, or an accessory. The evidence commitment may be a cryptographic commitment to indirect evidence from which the candidate target digital asset was reconstructed, the indirect evidence comprising at least one of rendered imagery or a text prompt. Gating acceptance may comprise operating an engine import gate that prevents the candidate target digital asset from being imported into the 3D rendering platform if the derived-asset receipt is invalid or missing. The candidate target digital asset, prior to being received, may have been stored as a 3D model in a central content database accessible via an Application Programming Interface (API). Verifying the derived-asset receipt may further comprise verifying a freshness seal included in the receipt, the freshness seal comprising a destination nonce to prevent replay of the receipt.

In another embodiment, a system for managing and governing portable digital avatars is provided. The system comprises one or more processors and non-transitory memory storing instructions that, when executed, cause the system to operate a content database configured to store a 3D model of a persistent avatar and one or more associated assets. The instructions further cause the system to operate a content delivery module configured to deliver the 3D model and its associated assets to a plurality of 3D rendering platforms via an Application Programming Interface (API). The instructions further cause the system to operate an enforcement point integrated into at least one of the plurality of 3D rendering platforms, the enforcement point configured to verify a derived-asset receipt associated with at least one of the associated assets and to block deployment or activation of the at least one associated asset in a regulated zone absent a valid derived-asset receipt.

In such embodiments, the derived-asset receipt may be verified to bind at least an evidence commitment for indirect evidence from which the associated asset was reconstructed, a pipeline identity commitment identifying a reconstruction pipeline, and a policy anchor referencing a machine-enforceable policy object. The enforcement point may be an engine import gate within one of the 3D rendering platforms.

In yet another embodiment, a computer-implemented method performed by a generation service for issuing verifiable continuity for reconstructed digital assets is provided. The method comprises receiving indirect evidence derived from a source digital asset. The method further comprises generating an output digital asset using a reconstruction pipeline characterized by a pipeline identity commitment. The method further comprises evaluating similarity under a similarity contract to determine a derived classification and a policy anchor. The method further comprises generating a derived-asset receipt binding at least an evidence commitment for the indirect evidence, the pipeline identity commitment, an output commitment for the output digital asset, and the policy anchor. The method further comprises delivering the output digital asset with the derived-asset receipt to a destination configured to deny acceptance of the output digital asset absent a valid derived-asset receipt.

In a further embodiment, a computer-implemented method performed by a marketplace system for governing the listing of reconstructed digital assets is provided. The method comprises receiving a listing request for a candidate target digital asset, wherein the asset is a component of a persistent digital avatar. The method further comprises obtaining a similarity contract applicable to the listing request. The method further comprises verifying a derived-asset receipt associated with the candidate target digital asset, the receipt binding at least an evidence commitment and a policy anchor. The method further comprises gating listing approval based on the verifying. The method further comprises, when a derived classification of the asset indicates a regulated zone, enforcing a machine-enforceable policy object referenced by the policy anchor to control at least one of listing visibility, monetization enablement, or settlement routing.

### General Implementation and Computing Environment

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media. Non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Any suitable computer usable or computer readable storage medium may be utilized. The computer-readable storage medium may be, for example, but is not limited to, an electronic, magnetic, optical, electromagnetic, infrared, or semiconductor system, apparatus, or device, or any suitable combination of the foregoing. More specific examples (a non-exhaustive list) of the computer-readable storage medium may include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), or a magnetic storage device. In the context of the present disclosure, a computer-readable storage medium may be any tangible medium that can contain or store a program for use by or in connection with an instruction execution system, apparatus, or device.

Computer program code for carrying out operations of the present disclosure may be written in any combination of one or more programming languages, including an object-oriented programming language such as Java, C++, or the like, and conventional procedural programming languages, such as the "C" programming language, Python, or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In some implementations, electronic circuitry including, for example, programmable logic circuitry, field-programmable gate arrays (FPGAs), or programmable logic arrays (PLAs) may execute the computer readable program instructions by utilizing state information of the computer readable program instructions to personalize the electronic circuitry, in order to perform aspects of the present disclosure.

### Interpretation of Terms and Flowcharts

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

Unless specified otherwise, the terms "perform," "calculate," "compute," "establish," "generate," "configure," "reconstruct," and the like preferably relate to operations and/or processes that change and/or generate data and/or convert the data into other data, wherein the data may be represented as physical variables, for example, in the form of electrical impulses. The expression "computer" should be interpreted as broadly as possible to cover all electronic devices having data processing properties.

### Concluding Remarks

The foregoing descriptions of specific embodiments of the present disclosure have been presented for purposes of illustration and description. They are not intended to be exhaustive or to limit the present disclosure to the precise forms disclosed, and many modifications and variations are possible in light of the above teaching. The example embodiments were chosen and described in order to best explain the principles of the present disclosure and its practical applications, to thereby enable others skilled in the art to best utilize the present disclosure and various embodiments with various modifications as are suited to the particular use contemplated. It is intended that the scope of the disclosure be defined by the Claims appended hereto and their equivalents.

1. A computer-implemented method for governing portable digital assets, the method comprising:
(a) at a destination content pipeline, receiving a candidate target digital asset for inclusion in a 3D rendering platform, wherein the candidate target digital asset is a component of a persistent digital avatar;
(b) obtaining a similarity contract that specifies at least a derived classification zone and a machine-enforceable policy requirement for assets classified therein;
(c) verifying a derived-asset receipt associated with the candidate target digital asset, the receipt providing a cryptographic binding between at least an evidence commitment, a pipeline identity commitment, and a policy anchor; and
(d) gating acceptance of the candidate target digital asset into the 3D rendering platform based on the verifying.

2. The method of claim 1, wherein the candidate target digital asset is one of: a 3D avatar model, a cosmetic skin, an article of clothing, or an accessory.

3. The method of claim 1, wherein the evidence commitment is a cryptographic commitment to indirect evidence from which the candidate target digital asset was reconstructed, the indirect evidence comprising at least one of rendered imagery or a text prompt.

4. The method of claim 1, wherein gating acceptance comprises operating an engine import gate that prevents the candidate target digital asset from being imported into the 3D rendering platform if the derived-asset receipt is invalid or missing.

5. The method of claim 1, wherein the candidate target digital asset, prior to being received, was stored as a 3D model in a central content database accessible via an Application Programming Interface (API).

6. The method of claim 1, wherein verifying the derived asset receipt further comprises verifying a freshness seal included in the receipt, the freshness seal comprising a destination nonce to prevent replay of the receipt.

7. A system for managing and governing portable digital avatars, the system comprising: one or more processors and non-transitory memory storing instructions that, when executed, cause the system to:
(a) operate a content database configured to store a 3D model of a persistent avatar and one or more associated assets;
(b) operate a content delivery module configured to deliver the 3D model and its associated assets to a plurality of 3D rendering platforms via an Application Programming Interface (API); and
(c) operate an enforcement point integrated into at least one of the plurality of 3D rendering platforms, the enforcement point configured to:
(i) verify a derived-asset receipt associated with at least one of the associated assets; and
(ii) block deployment or activation of the at least one associated asset in a regulated zone absent a valid derived asset receipt.

8. The system of claim 7, wherein the derived-asset receipt is verified to bind at least an evidence commitment for indirect evidence from which the associated asset was reconstructed, a pipeline identity commitment identifying a reconstruction pipeline, and a policy anchor referencing a machine-enforceable policy object.

9. The system of claim 7, wherein the enforcement point is an engine import gate within one of the 3D rendering platforms.

10. A computer-implemented method performed by a generation service for issuing verifiable continuity for reconstructed digital assets, the method comprising:
(a) receiving indirect evidence derived from a source digital asset;
(b) generating an output digital asset using a reconstruction pipeline characterized by a pipeline identity commitment;
(c) evaluating similarity under a similarity contract to determine a derived classification and a policy anchor;
(d) generating a derived-asset receipt binding at least an evidence commitment for the indirect evidence, the pipeline identity commitment, an output commitment for the output digital asset, and the policy anchor; and
(e) delivering the output digital asset with the derived-asset receipt to a destination configured to deny acceptance of the output digital asset absent a valid derived-asset receipt.

11. A computer-implemented method performed by a marketplace system for governing a listing of reconstructed digital assets, the method comprising:
(a) receiving a listing request for a candidate target digital asset, wherein the asset is a component of a persistent digital avatar;
(b) obtaining a similarity contract applicable to the listing request;
(c) verifying a derived-asset receipt associated with the candidate target digital asset, the receipt binding at least an evidence commitment and a policy anchor;
(d) gating listing approval based on the verifying; and
(e) when a derived classification of the asset indicates a regulated zone, enforcing a machine-enforceable policy object referenced by the policy anchor to control at least one of listing visibility, monetization enablement, or settlement routing.

12. A non-transitory computer-readable medium storing instructions that, when executed by one or more processors, cause a computing system to perform the method of claim 1.

13. A non-transitory computer-readable medium storing instructions that, when executed by one or more processors, cause a computing system to perform the method of claim 10.
